(19) United States
(12) Patent Application Publication
(10) Pub. No.: US 2002/0042731 A1
(43) Pub. Date: Apr. 11, 2002

(54) Method, system and tools for performing business-related planning

(76) Inventors: Joseph A. King JR., Midlothian, VA (US); Gary F. Baker, Westfield, MA (US); Justine M. Metz, New York, NY (US); Ramon Soto, Fairfield, CT (US)

Correspondence Address: HUNTON & WILLIAMS, INTELLECTUAL PROPERTY DEPARTMENT, 1900 K STREET, N.W., SUITE 1200, WASHINGTON, DC, 20006-1109, US

(21) Appl. No.: 09/682,227

(22) Filed: Aug. 8, 2001

Related U.S. Application Data
(60) Provisional application No. 60/238,013, filed on Oct. 6, 2000.

(51) Int. Cl. G06F 17/60

(52) U.S. Cl. 705/10

(57) ABSTRACT

A business planning technique uses a structured process for providing a marketing solution to an organization. The technique includes the steps of: (a) in a first stage, chartering the process by defining its objective based on input from at least one senior leader of the organization, and developing a plan for collecting data to reach that objective; (b) in a second stage, gathering data pertaining to the organization's environment from secondary and primary sources, and performing preliminary structuring and assessment of such data; and (c) in a third stage, conducting a strategic workout session with the at least one senior leader, including developing, bundling and prioritizing solutions; and (d) in a fourth stage, conducting a tactical workout session, including allocating resources to implement a selected solution. The technique uses various tools to perform the tasks defined by the structured process, such as a SWOT tool, a strategy prioritization tool, a market prioritization tool, a multi-blocker (e.g., GE 9-blocker) tool, a risk verses newness tool, etc.

### CROSS REFERENCE TO RELATED APPLICATIONS

This application claims the benefit of U.S. Provisional Application No. 60/238,013, filed on Oct. 6, 2000, which is incorporated herein by reference in its entirety.

### BACKGROUND OF THE INVENTION

The present invention relates to a method, system and tools for performing business-related planning. In a more particular embodiment, the present invention relates to a method, system and tools for developing a strategic business plan and its tactical execution.

Many organizations rely on a marketing department (or other marketing-related personnel) to assess a business” competitive position within the market and to develop and recommend marketing plans based thereon. Such a task is notoriously complex. Accordingly, many organizations apply a loosely defined and intuitive approach to this problem. For instance, the marketing department may initiate the process by haphazardly collecting information pertaining to the business practices of the organization and the characteristics of its relevant markets. The marketing department may then select one or more off the shelf analysis tools to analyze the data using an equally loose and undisciplined approach.

Upon completion of its analysis, the marketing department may then seek the approval of senior leaders within the organization. If approval is obtained, the marketing department may then attempt to roll out the plan by informing others in the organization of their role in bringing the plan to fruition, such as by notifying the finance department and information technology (IT) department of their roles in implementing the business plan.

Such an approach is problematic. For instance, the unstructured collection of data may leave gaps in the marketing department's understanding of the organization and its relevant markets. The unstructured application of standard tools may also produce unsatisfactory and unpredictable results. As a result, the marketing department may need to go back to the drawing board to collect additional data, and/or to adopt different analysis tools. Thus, this approach essentially relies on trial and error to provide business solutions, with consequent waste of time and resources.

Further, the isolated planning performed by the marketing department is itself problematic. As appreciated by the present inventors, the lack of communication with other entities in the organization may result in the development of a marketing plan that is poorly aligned with the needs and objectives of the organization (e.g., as articulated by the senior leadership of the organization). And even if the senior leadership signs on to the plan, other departments in the organization may raise objections to the feasibility and/or desirability of the plan. For instance, finance personnel may inform the marketing department that its plans are inconsistent with the budgetary constraints placed on the organization, and/or technical personnel may state that the plans are incompatible with the technical infrastructure of the organization. These obstacles may prevent the marketing department from implementing the plan, or may require time-intensive and expensive revision of the plan. The process flow in these circumstances suffers from lack of communication; in other words, the front end of the process (i.e., the initial planning preparation procedure) is not satisfactorily tied to the back end of the process (i.e., the later phases of the planning process, including the tactical aspects of the planning process).

Further, marketing personnel may lack adequate tools for performing reliable business planning. For instance, various tools exist in the art for prioritizing business options based on various factors. However, these tools may have been designed to serve a specific planning project, and may thus lack general applicability to other planning projects. Further, these tools may serve to simply parrot the analyst's preconceived notions regarding the relative desirability of different business options, irrespective of the objective relative merits of the options. For instance, these tools may allow a user to place a heavy subjective weight on a favored option to steer the ranking towards predetermined ends.

Known techniques may suffer from additional unspecified deficiencies.

Accordingly, there is a general need for more satisfactory techniques and tools for performing business-related planning.

### SUMMARY OF THE INVENTION

The above identified needs, as well as other unspecified needs, are satisfied by the method, system and tools disclosed herein.

One exemplary aspect of the invention pertains to a technique for performing business planning using a structured process, so as to provide a marketing solution to an organization, comprising the steps of: (a) in a first stage, chartering the process by defining its objective based on input from at least one senior leader of the organization, and developing a plan for collecting data to reach that objective; (b) in a second stage, gathering data pertaining to the organization's environment from secondary and primary sources, and performing preliminary structuring and assessment of such data; and (c) in a third stage, conducting a strategic workout session with the at least one senior leader, including developing, bundling and prioritizing candidate solutions; and (d) in a fourth stage, conducting a tactical workout session, including allocating resources to implement a selected solution.

The technique uses various tools to perform the tasks defined by the structured process. One such tool applies a strategy prioritization procedure, comprising the steps of: (a) identifying a plurality of candidate strategies for achieving the marketing solution, wherein the procedure defines a plurality of variables that describe respective properties of the strategies; (b) specifying values for the variables which reflect the extent to which the strategies embody the properties; (c) summing the values for each of the strategies to produce a plurality of sum values; and (d) ranking the strategies based on the plurality of sum values.

Addition features of the present invention (including additional tools used by the technique) are set forth below.

### BRIEF DESCRIPTION OF THE DRAWINGS

The present invention can be understood more completely by reading the following Detailed Description of exemplary embodiments, in conjunction with the accompanying drawings, in which:

FIGS. 1A-1N together describe a structured process for performing business related planning according to the present invention;

FIG. 2 shows an exemplary system for implementing the process shown in FIGS. 1A-1N;

FIG. 3 describes an exemplary database for storing information used in the process shown in FIGS. 1A-1N;

FIG. 4 shows an exemplary main screen page for presenting information pertaining to principal steps in the process;

FIG. 5 shows an exemplary screen page for presenting information pertaining to one of the principal steps listed in FIG. 4;

FIG. 6 shows a thermometer display screen for presenting an overview of the level of completion of the process; and

FIGS. 7-20 show various tools for assisting the user in performing various principal steps and substeps described in FIGS. 1A-1N.

### DETAILED DESCRIPTION OF THE INVENTION

1. Exemplary Structured Process

1(a). Overview of Process

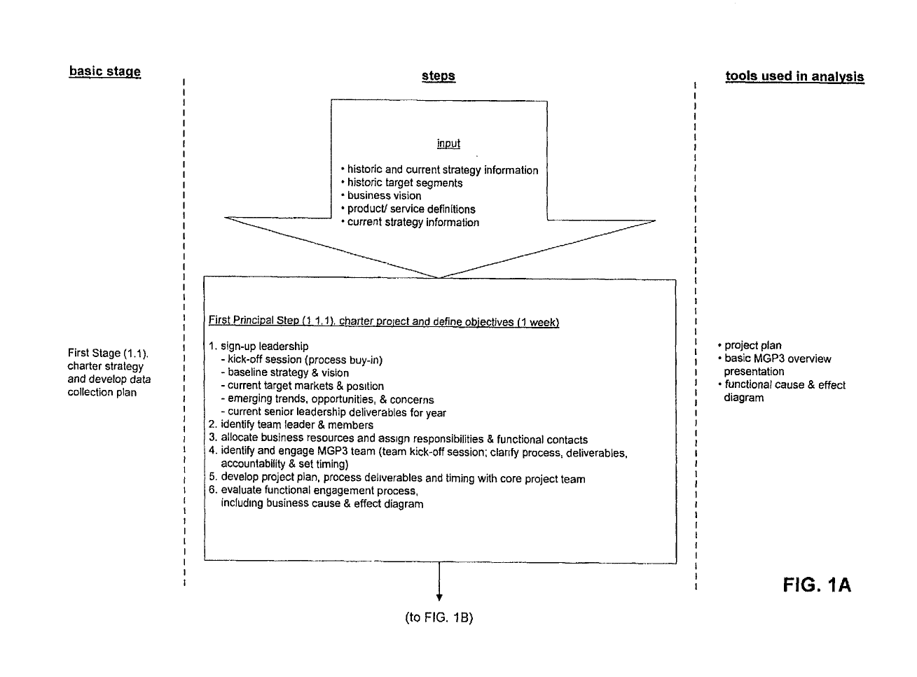

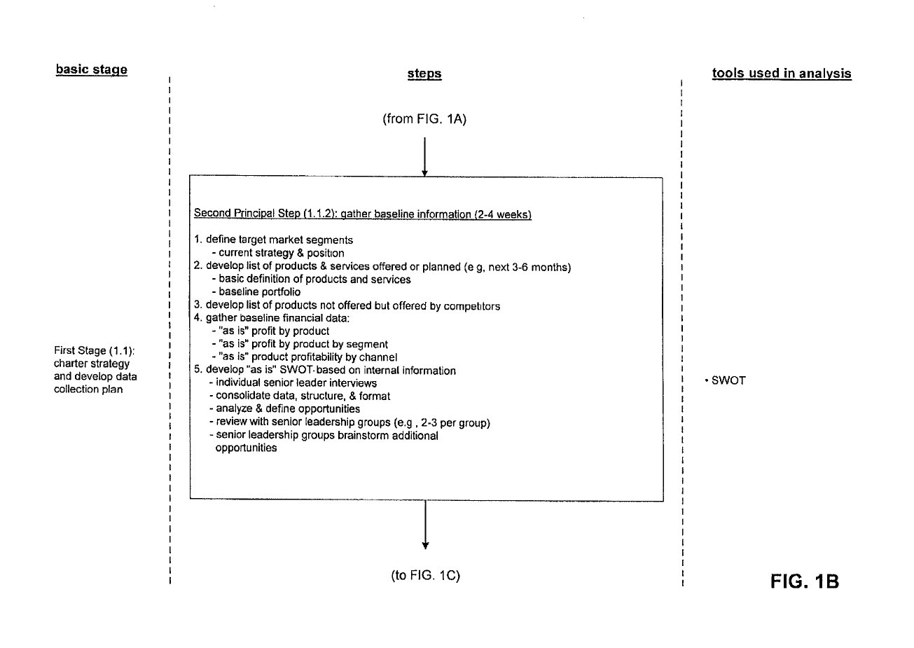

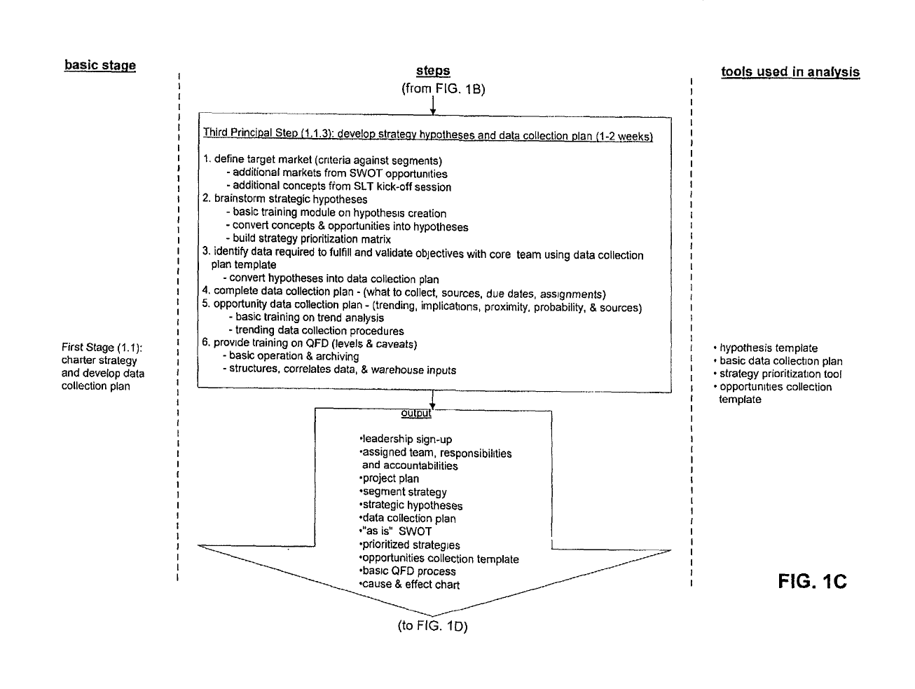

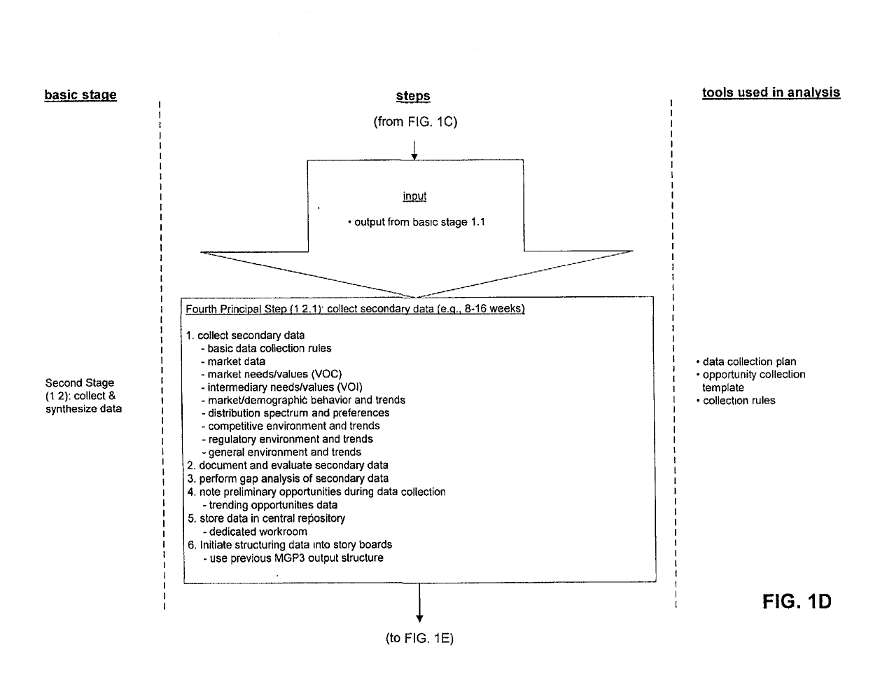

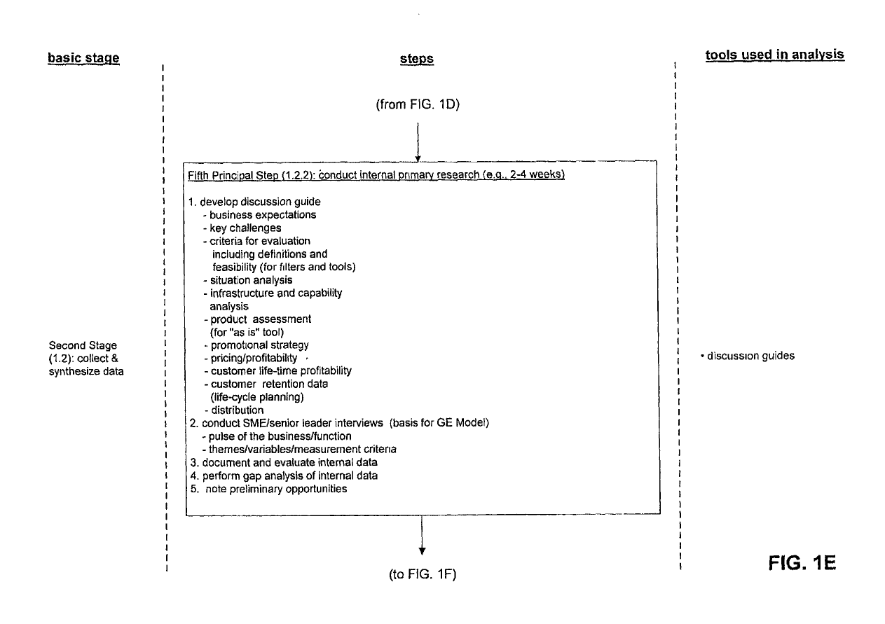

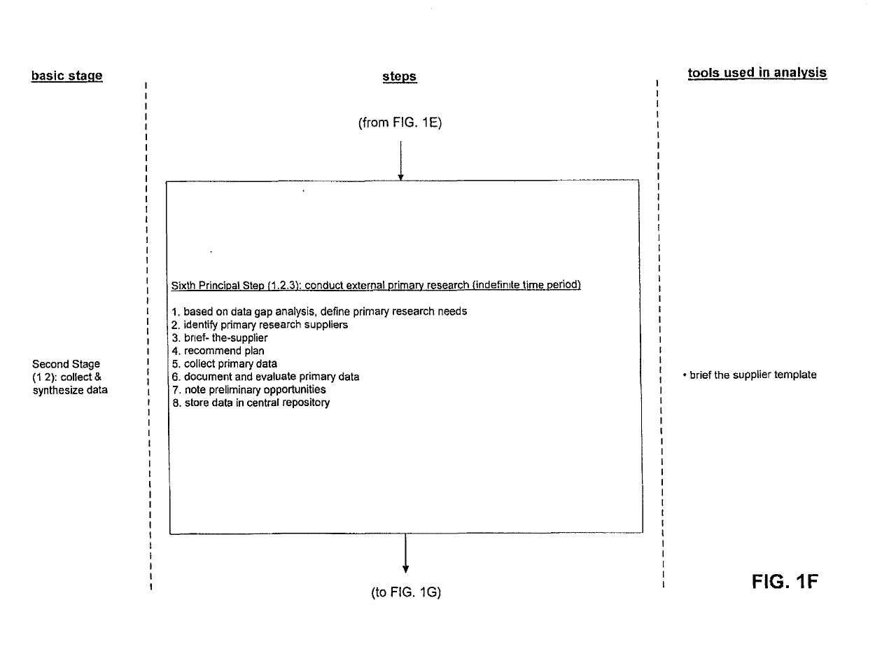

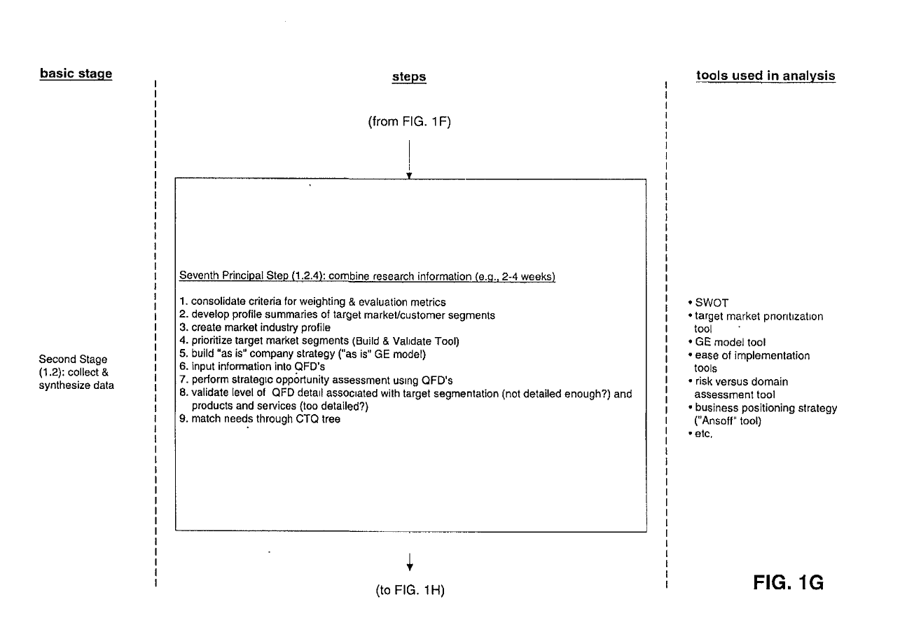

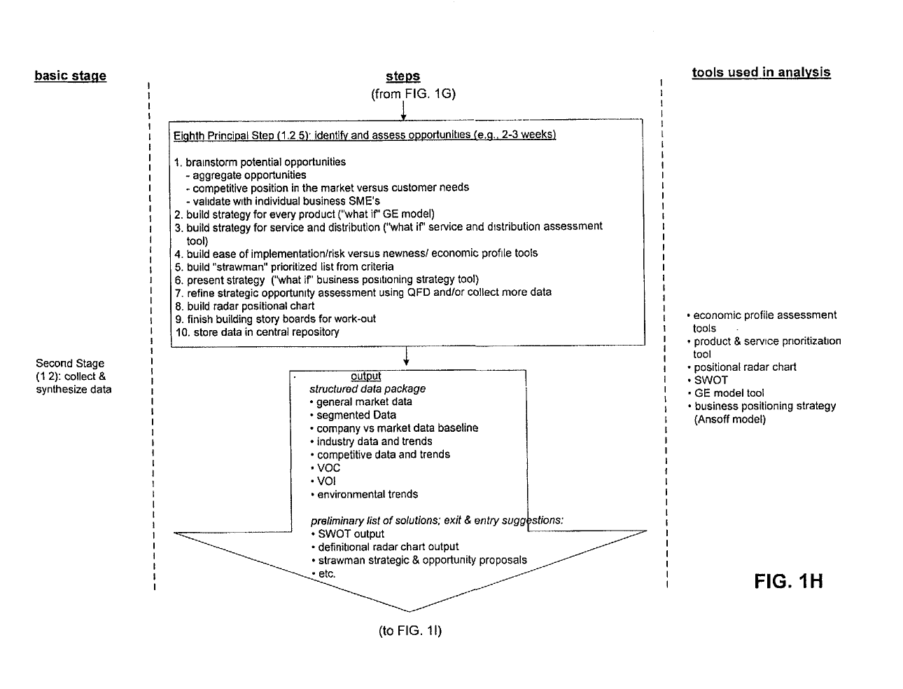

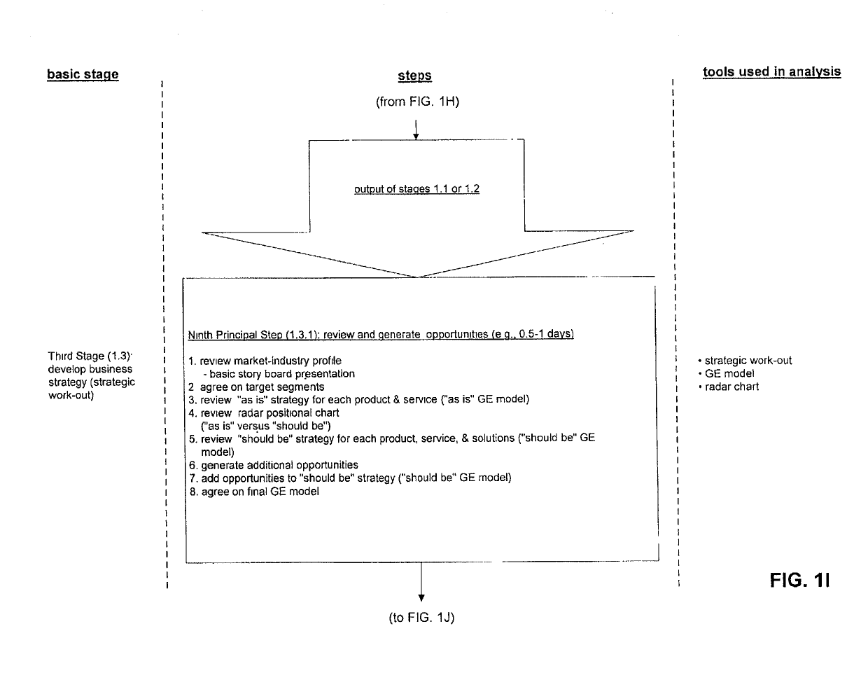

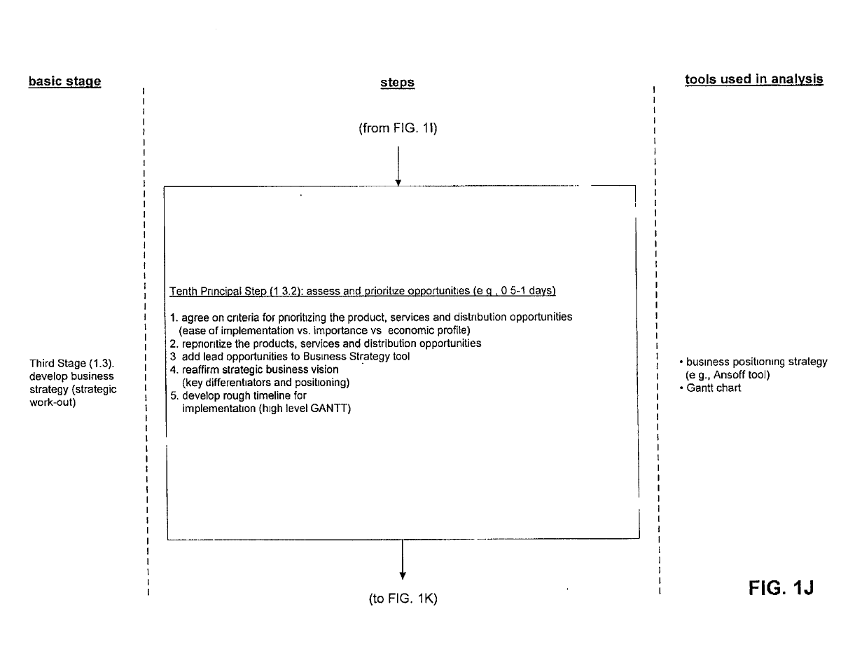

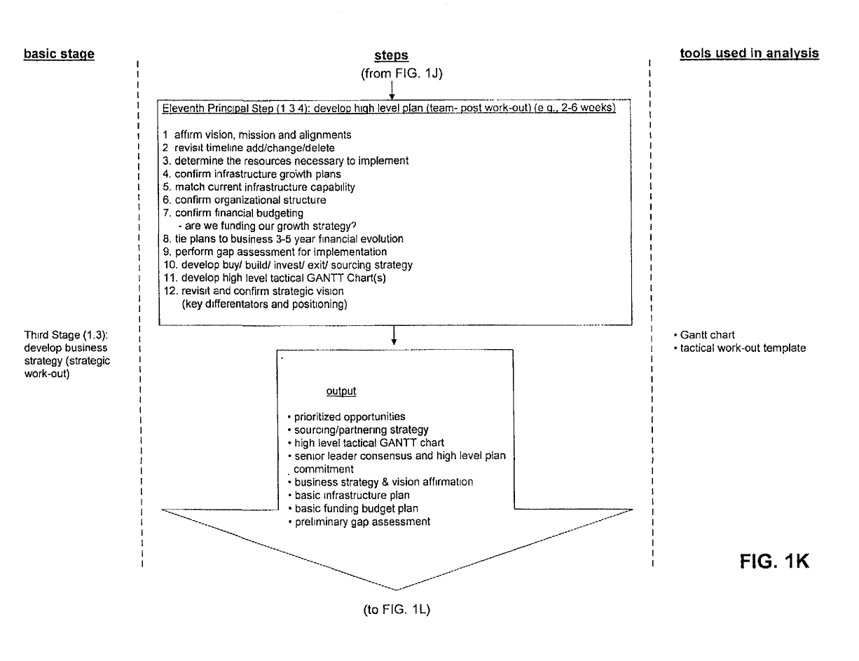

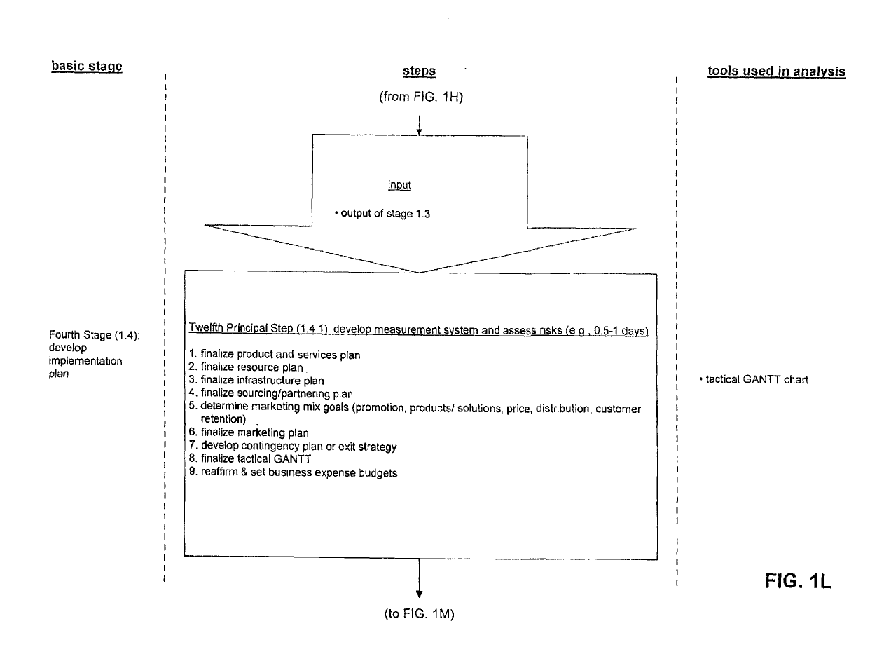

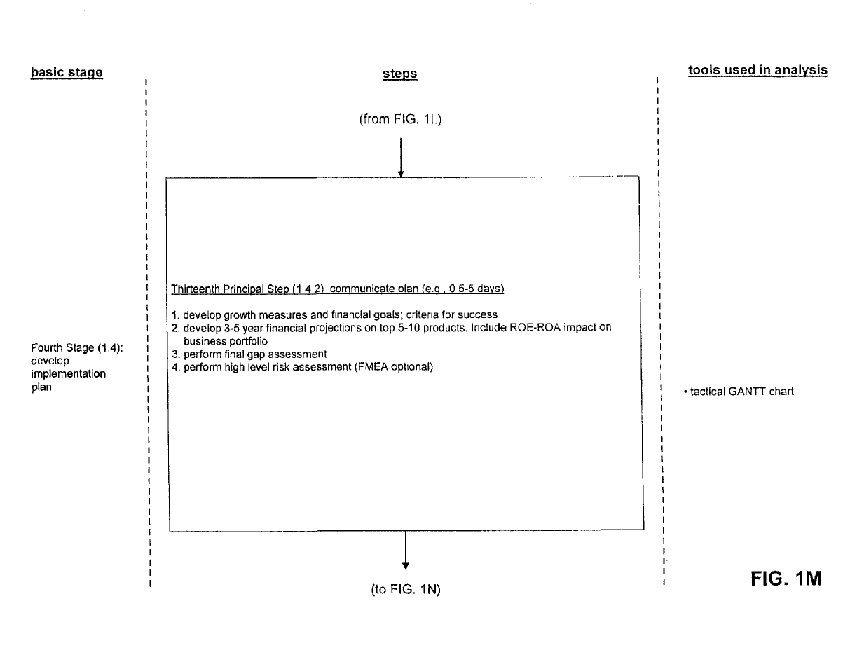

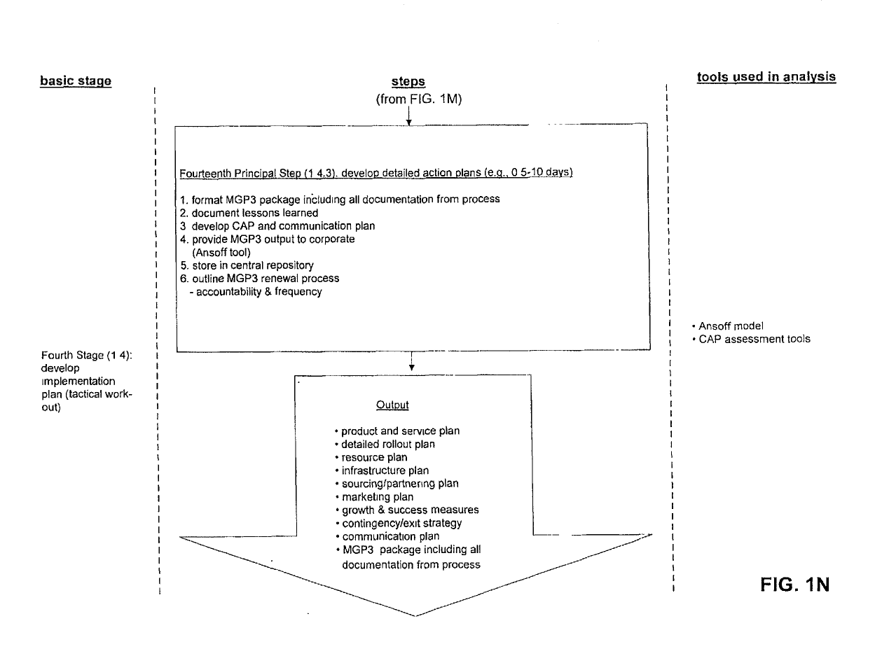

FIG. 1 (including FIGS. 1A-1N) identifies exemplary steps in a process for performing business planning. The process may be used by one or more individuals (referred to as a planning team) to provide a business-related solution to a target entity. For instance, in one embodiment, a business planning team within an organization may use the process to provide a business solution for use by the organization (or to some department, division, affiliate or subsidiary thereof). The process may also be used by the team to provide a business solution to an external individual or organization (such as an organization which receives the benefit of the process in response to paying a fee or other type of consideration). In the context used here, the term organization may refer to any type of business organization, such as a corporation, partnership, etc. Further, the term organization also encompasses non-profit organizations, government organizations, academic organizations, or even a single individual conducting some type of business, etc.

The term senior leaders (or Senior Leadership Team (SLT)) describes personnel within an organization who have the authority to adopt, modify, or reject solutions recommended by the marketing team. In a typical business scenario, these individuals may comprise high-level management and/or executive personnel within an organization, such as Chief Executive Officers (CEOs), presidents, etc.

The above-referenced solution includes any type of recommended action intended to provide some benefit to the organization. Typically, the solution will take the form of a recommendation and action plan to introduce products and/or services (either new or existing) into an identified market (using either new or existing channels). However, the solution may encompass other types of actions that the organization may perform to improve its competitive advantage, such as advertising program changes, organizational realignment changes, personnel changes, information technology changes, etc.

By way of overview, the process includes four stages, which are identified in the left column of FIG. 1. The first stage involves chartering the project and developing a data collection plan. In other words, this stage entails initiating the process by performing various preparatory and foundation-laying tasks based on the initial input from the senior leaders in a kick off session. For instance, this stage involves defining the basic approach of the planning process, and setting forth a plan for collecting information that will be used as input for the various analytical tools used in the process. The second stage involves gathering information pertaining to emerging trends, market/environmental influences, business expectations, business capabilities, etc. This stage also entails performing preliminary data structuring and assessment of such information. The third basic stage includes conducting a strategic work out, in which the team presents its findings (e.g., as conveyed by storyboards generated in prior analyses) to the senior leaders (during, for instance, a day-long meeting with the senior leaders). The strategic workout may involve developing, bundling and prioritizing candidate solutions, and also creating consensus regarding the high-level strategy to be used. The fourth basic stage entails conducting a tactical workout session, including allocating resources to implement a selected solution. This stage also involves developing measurements of success for use in evaluating the success of the implementation.

The overall process is referred to herein as Multi-Generation Product and Process Plan Template (MGPPP or MGP³). Reference to multi-generation indicates that the process links and interrelates multiple planning activities into a comprehensive process plan.

Each of the stages may include plural principal steps. The principal steps pertain to basic tasks performed in conducting the business planning. In the example discussed herein, the process includes fourteen such principal steps. As to the first stage, the first principal step (identified in FIG. 1A as principal step 1.1.1) entails chartering the project and defining its objectives, or in other words, establishing its core focus. The second principal step (identified in FIG. 1B as principal step 1.1.2) involves gathering baseline information for performing the process. Baseline information refers to information that reflects the current state of affairs in the organization and/or its relevant business environment (e.g., including its markets). The third principal step (identified in FIG. 1C as principal step 1.1.3) entails developing strategy hypotheses and a data collection plan. That is, each piece of information to be collected is targeted at answering a specific question or series of questions. In the context used here, each question to be answered defines a hypothesis.

As to the second stage, the fourth principal step (identified in FIG. 1D as principal step 1.2.1) entails collecting and analyzing secondary data. That is, at the beginning of the second stage, the team has already outlined the principal objectives and features of a data collection plan. The fourth principal step involves initiating the data collection procedure by first examining secondary data from secondary sources. Secondary data comprises previously prepared information, e.g., from public sources or subscription. After extracting information from secondary sources, the team then collects primary data to further supplement its knowledge base (e.g., if such information is needed but cannot be found from less expensive secondary sources). Primary data generally comprises information that the team generates itself (or commissions others to develop). More specifically, the fifth principal step (identified in FIG. 1E as principal step 1.2.2) first attempts to collect needed data from internal primary sources. That is, in this principal step, the team first looks to its own resources to extract needed information. The sixth principal step (identified in FIG. 1F as principal step 1.2.3) entails conducting external primary research, if necessary. In the context used here, external research may comprise research obtained from resources that are external to the organization. The seventh principal step (identified in FIG. 1G as principal step 1.2.4) involves combining and analyzing research information. The eighth principal step (identified in FIG. 1H as principal step 1.2.5) involves identifying and assessing opportunities. An opportunity may comprise a new market that the organization may wish to target, a product benefit or service that the organization may wish to develop, a new channel or distribution that the organization may wish to exploit or introduce, etc.

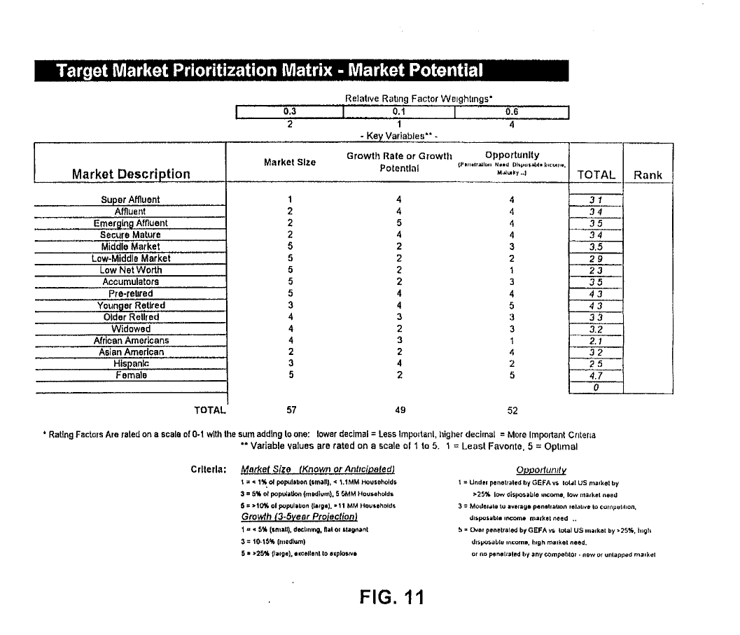

As to the third stage, the ninth principal step (identified in FIG. 11 as principal step 1.3.1) entails reviewing and generating opportunities. The tenth principal step (identified in FIG. 1J as principal step 1.3.2) involves assessing and prioritizing opportunities. The eleventh principal step (identified in FIG. 1K as principal step 1.3.4) involves developing a high level plan for carrying out the marketing solutions.

As to the fourth stage, the twelfth principal step (identified in FIG. 1L as principal step 1.4.1) involves developing a measurement system and assessing risks. The thirteenth principal step (identified in FIG. 1M as principal step 1.4.2) involves communicating the plan, including performing financial projections and risk analysis. And the fourteenth principal step (identified in FIG. 1N as principal step 1.4.3) involves developing detailed action plans to implement the solution.

Further, FIG. 1 indicates that each of the principal steps includes one or more substeps. The substeps describe subtasks pertaining to the basic tasks defined by the associated principal steps. The subtasks generally provide a structure and rigor in performing the principal tasks. In one embodiment, the substeps are invariably executed in a prescribed order, such as the prescribed order described below. In another embodiment, the team uses the process only as a general guideline in executing the substeps. In this case, the team may decide to execute the substeps out of sequence. For example, one or more substeps within a principal step may be executed in a different order than is described below. Further, one or more substeps in a principal step may be put on hold, and then executed in a subsequent principal step. Further, one or more substeps in a principal step may be performed in advance, e.g., before reaching that principal step. Further, one or more substeps may be performed in parallel.

The process may also include a plurality of tollgates for check or review points interspersed throughout the process. For instance, the process may position such tollgates after selected principal steps. These tollgates define checkpoints (or review points) in the process where appropriate individuals (referred to herein as authorizing agents) verify whether the process has achieved certain expected results in its current state of development. If the process has achieved such results, the team moves on to execute subsequent steps in the process. If the process fails to achieve such results, the team may decide to repeat one or more of the previous tasks in the process, or may decide to terminate the process (e.g., in the event the continuation of the process is not feasible in view of one or more insurmountable obstacles discovered in the course of performing the process). The inclusion of these tollgates helps ensure that an untenable process does not advance too far before its weaknesses are discovered. Thus, the use of tollgates enables the team to better manage planning resources.

According to exemplary embodiments, the business planning team performs decision-making for selected tollgates. Thus, while the process requires the input of senior leaders, and the eventual approval of senior leaders, it does not otherwise monopolize the time resources of the senior personnel within the organization by requiring these individuals to attend intermediary tollgate meetings.

Selected principal steps, substeps, and/or approval procedures may rely on various tools to perform analysis. A tool refers to any type of technique, device, routine, etc. to provide a business-related task, such as a task relating to analysis, data structuring/formatting, recording keeping, etc. The right-hand column of FIG. 1 shows exemplary tools that may be used in performing the principal steps listed adjacent thereto (in the middle column).

The principal steps, substeps, approval procedures and tools collectively define an integrated methodology for performing business planning. That is, the results of each principal step serve as input for subsequent principal steps. Further, unlike many known systems, the output of one tool often serves as input to a downstream tool (i.e., a tool used later in the process).

In addition, individual principal steps and substeps may serve as separate routines with self-contained utility. Likewise, selected tools may have self-contained utility. That is, selected steps and tools may be used within other processes, or as standalone means for analysis.

Having described the process for conducting business planning in general terms, it is now possible to discuss the individual principal steps, substeps, and tools in greater detail below. Section No. 3 also provides additional details regarding the tools that may be used in the multi-generation process.

1(b). First Stage, 1.1: Charter Project and Define Objectives

1(b)(i). Overview of First Stage

The first stage involves chartering the project and developing a data collection plan. In other words, this stage entails initiating the process by performing various preparatory and foundation-laying tasks, such as defining the basic approach of the planning process, and setting forth a plan for collecting information that will be used as input for the various analytical tools used in the process. In an exemplary business environment, the first stage may include three principal steps and may be completed in about 3-7 weeks.

1(b)(ii). First Principal Step, 1.1.1: Charter Project and Define Objectives

The first principal step (identified in FIG. 1A as principal step 1.1.1) entails chartering the project and defining its objectives, or in other words, establishing its core focus. In one exemplary embodiment, this principal step includes six substeps. The first (1) substep involves securing the support and cooperation of the organization's senior leadership (e.g., obtaining the sign on of the leadership). To perform this task, the individuals that are initiating the process (referred to as process initiators herein) may arrange and conduct a kick-off session with the senior leaders. In this session, the initiators describe the plan to the senior leaders. The process initiators may present a document that summarizes the process to facilitate explanation of the process (referred to as a multi-generation overview presentation).

The first substep also involves answering the leaders” questions, identifying the leaders” objectives and needs, etc. The first substep may also entail identifying the business-related disposition of the organization, such as its baseline strategy and vision (e.g., defining the organization's current business practices and its own conception of its role in the market), current target markets and position in those markets, emerging market trends, business concerns/worries, and business opportunities. The first substep may also entail identifying the deliverables that the organization is expected to produce for the current year. This matter merits attention because the leaders are not likely to be receptive to long-range plans to improve the organization that do not also satisfactorily address the year-end demands placed on the organization. As the reader will therefore appreciate, the above-referenced core focus of the process is shaped early in the process in large part based on attentively listening to what the senior leaders have to say about their organization (as opposed to other market strategy approaches which include initial stages in which the marketing department performs its function in a virtual vacuum with respect to other departments within the organization).

The second (2) substep entails defining the composition of the team that will orchestrate the process. In one exemplary business environment, the team may include four to six people. This step may entail defining each team member's role and accountability in the process. Whenever possible, the team may seek to quantify each team member's role and accountability by assigning specific expectations for each team member (such as a percentage of time that each team member is expected to devote to identified tasks).

The third (3) substep entails allocating business resources and assigning responsibilities and functional support members. Functional support members include individuals having different expertise who may be consulted in performing identified tasks in the process. In this sense, these support members may be thought of as extended members of the process team. This step also involves communicating with the identified support members to ensure that they are alerted to their role in the process (and will therefore not be surprised when they are called on at an appropriate juncture in the process).

The fourth (4) substep step entails engaging the team. This substep entails discussing and clarifying the process among team members, to make sure that everyone in the team is aware of the expectations placed on the team (including deliverables that the team is expected to produce at various junctures in the process). The team may also seek to ensure that members understand their accountability in the process (including an understanding of what they are expected to deliver, and when they are expected to deliver it). The team may choose to convey this information in a team kick-off session.

The fifth (5) substep entails developing a project plan, discussing deliverables that will be generated by the plan, and discussing the timing at which various events will occur in the process.

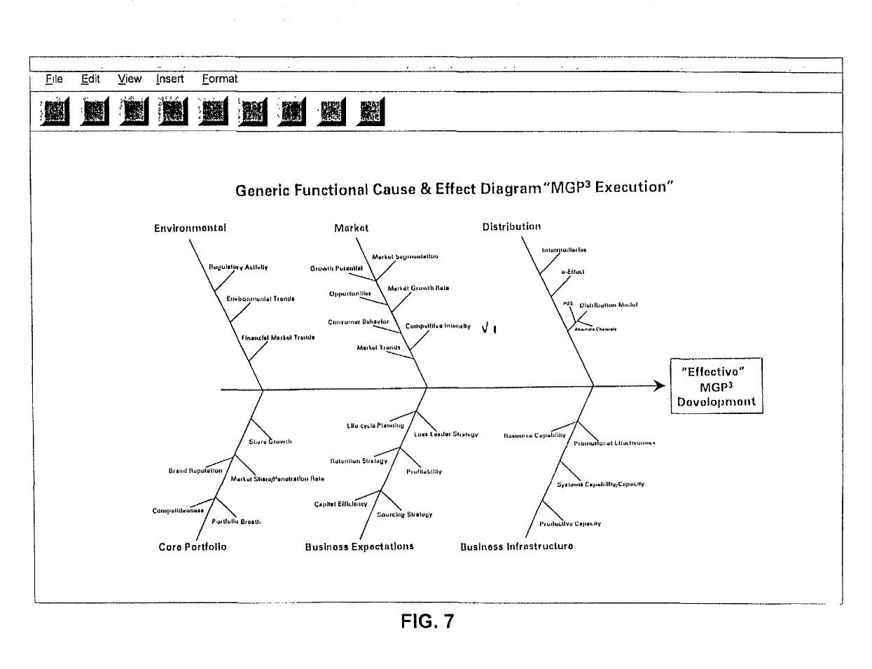

The sixth (6) substep entails evaluating the functional engagement process. To facilitate this process, the team may prepare and analyze a business cause and effect diagram. Such a diagram may use an inverted tree-structure to show how different attributes of the organization (and its environment) filter down and affect the organization's overall operation. That is, different branches in the tree represent different attributes. The team may trace the impact of different attributes by tracing how these attributes connect to and thereby affect the organization's more general characteristics (represented by the trunk of the tree). Section No. 3 (below), in conjunction with FIG. 7, provide addition details regarding this tool.

In an exemplary business environment, the first principal step may take approximately one week to complete.

1(b)(iii). Second Principal Step, 1.1.2: Gather Baseline Information

The second principal step (identified in FIG. 1B as principal step 1.1.2) involves gathering baseline information for performing the process. Baseline information refers to information that reflects the current state of affairs in the organization and/or its relevant business environment (e.g., including its markets). In one exemplary embodiment, the second principal step includes five substeps. The first (1) substep entails identifying the different market populations currently targeted by the organization (referred to as target market segments), as well as the basic marketing strategies applied in those market segments, and the organization's competitive position in those market segments.

The second (2) substep entails developing a list of products and services that the organization is currently providing, or is planning to provide in the near future (e.g., within the next 3-6 months), as well as defining the market segments in which these products and services are provided. The organization's current sales activity (defined by what is sold and where it is sold) constitutes a baseline portfolio.

The third (3) substep comprises developing a list of products and services offered by competitors. That is, this substep aims to compile a list of primary competitors of the organization (e.g., the organization's top ten competitors), and then identify the marketing activities of these competitors in relevant market segments (with particular emphasis on what the competitors are doing differently than the organization in these segments).

The fourth substep entails gathering baseline financial data, including: (a) as is profit by product information; (b) as is profit by product by marketing segment information; and (c) as is product profitability by channel information. An as is profit by product analysis identifies the profit earned with respect to products (and/or services) currently offered by the organization. An as is profit by product by segment analysis identifies the profit earned with respect to products (and/or services) within specific identified market segments. An as is profit by channel analysis reflects profit earned using various distribution channels. Collectively, this information provides a picture of the organization's current product-related financial standing in the market. In turn, this information allows the team to better identify the particular aspects of the organization that would benefit from a marketing change (as opposed to other aspects of the organization that are functioning at adequate levels of performance, and therefore do not warrant change). In other words, this substep serves the beneficial purpose of identifying opportunities for improvement within the organization.

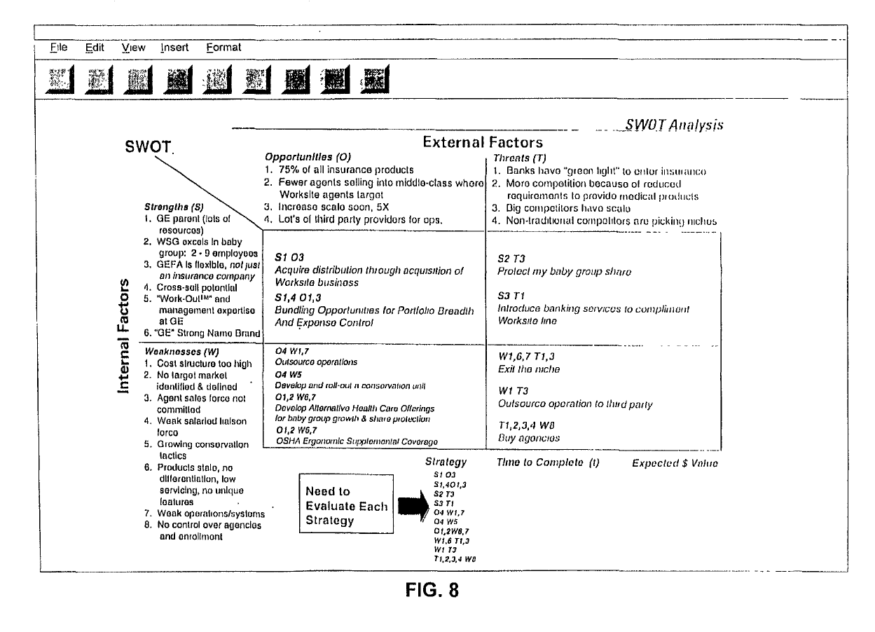

The fifth (5) substep entails developing an as is SWOT based on internal information (where SWOT is an acronym for Strengths, Weaknesses, Opportunities, and Threats). FIG. 8 shows an example of the SWOT tool as applied to one exemplary business setting. As shown there, this tool includes a four-block grid for identifying strategies that may be used by the organization to market its products and services. The right side of the grid lists various strengths and weaknesses of the organization. These factors reflect characteristics of the organization which may be attributed to its internal makeup/constitution. The top side of the grid lists various opportunities presented to the organization and various threats facing the organization. These factors reflect characteristics of the organization's environment. For instance, an exemplary opportunity may identify a market segment that is current under-exploited by competitors, thus representing an opportunity for exploitation by the organization. An exemplary threat may identify any type of potential impediment to the organization's profitability, such as competitive threats, regulative threats, etc.

Within the grid itself, the upper-left box identifies those strategies that are appropriate in view of the identified strengths of the organization, coupled with its identified opportunities. The lower-left box identifies those strategies that are appropriate in view of the identified weaknesses of the organization, coupled with its identified opportunities. The upper-right box identifies those strategies that are appropriate in view of the organization's identified strengths, coupled with its identified threats. And the lower-right box identifies those strategies that are appropriate in view of the organization's identified weaknesses coupled with its identified threats. The tool may label the strategies placed in the boxes using appropriate codes to reflect the considerations on which they are based (e.g., using symbols S, W, O, and T to represent the type of factors that the strategy addresses, i.e., corresponding to Strengths, Weaknesses, Opportunities, Threats, etc.).

An as is SWOT analysis is specifically based an assessment of the existing Strengths, Weaknesses, Opportunities, and Threats of the organization. To assess these factors, the team may conduct one-on-one interviews with the senior leaders. The output of the as is SWOT analysis may then be further refined by structuring and formatting the output into a more logical and cohesive informational framework (e.g., so that it more effectively tells a story). The team may then meet with small groups of senior leaders (e.g., 2-3 per group) to discuss the results of the SWOT analysis. This, in turn, may allow the team to engage in brainstorming with the small groups to identify yet further opportunities or strategies.

The active involvement of the entire senior leader team in the SWOT analysis is a departure from standard use of SWOT analysis in business settings. More specifically, many businesses entrust marketing personnel within a marketing department to perform limited SWOT analysis based on their own perspective of a problem under consideration. While conclusions from this analysis may eventually filter up to the senior leadership level, the senior leaders are not engaged in the generation and evolution of the actual analysis (e.g., the senior leaders do not actually contribute to the analysis). This is an example of the present technique's cross-functional approach to business plan development that represents a departure from classical business analysis in the marketing disciplines.

Further, many businesses use SWOT analysis as a starting and ending point in performing analysis on a very narrowly defined problem. In the present technique, the output of the SWOT analysis is fed to other tools, and the output of these other tools, in turn, feeds other tools. The technique may thus be conceptualized as a collection of tool-based processing stations arranged in an assembly line, each station extracting further insights from the conclusions reached by its predecessors.

At the conclusion of the second principal step, the team has now established a baseline for the organization, which defines how the organization understands its target market, current products/services, commercial strengths provided by its products/services, etc.

In an exemplary business environment, the second principal step takes approximately two to four weeks to complete.

1(b)(iv). Third Principal Step, 1.1.3: Develop Strategy Hypotheses and Data Collection Plan

The third principal step (identified in FIG. 1C as principal step 1.1.3) entails developing strategy hypotheses and a data collection plan. In the context used here, a hypothesis methodology reflects a potential approach used to address a particular problem or answer an identified query. That is, each piece of information to be collected is targeted at answering a specific question or set of questions. Each question to be answered is defined as a hypothesis. For instance, the assertion We believe that New York is large market for variable annuities defines a hypothesis that needs to be validated via data collection. More specifically, the collected data will either validate or disprove this hypothesis. The hypothesis approach provides a structured framework for addressing questions and retrieving information. A data collection plan reflects a procedure for collecting information used to address the hypotheses (e.g., by validating the hypotheses).

The first (1) substep involves refining the team's definition of the organization's target market segments, e.g., by establishing screening criteria to identify and discriminate among the target markets. More specifically, the team may identify these markets based on insight gained through the use of SWOT analysis (in the second principal step), and through concepts conveyed in the kick-off meeting with senior leaders (in the first principal step).

The second substep (2) entails conducting brainstorming to develop strategic hypotheses. This may involve providing instruction for team members pertaining to the creation of hypotheses, converting concepts and opportunities into hypotheses, etc.

The second substep (2) then includes prioritizing strategies identified in the above analysis.

Section No. 3 (below) identifies one exemplary strategy prioritization tool for application in the multi-generation process. By way of overview, this tool uses the Socratic method by prompting the user to answer a plurality of questions regarding a list of strategies. More specifically, the questions prompt the user to assess the extent to which the strategies possess identified characteristics/properties. The tool may also present the user with a list of answers from which to choose in answering the questions, each answer having a numeric score associated therewith. These numeric values (referred to as delimiters) restrict the user's response to objective criteria, thereby preventing the user from forcing or gaming the analysis to confirm preconceived notions regarding the relative merit of the strategies. The tool then aggregates the numerical values for the respective strategies to derive a plurality of sum values. The tool then ranks the strategies based on relative magnitudes of the sum values. Further details regarding this tool are presented in section No. 3 (below).

The third (3) substep entails identifying data required to fulfill and validate the hypotheses” objectives, and validating the objectives with the team. This substep seeks to more clearly define the actual questions being pursued, which may comprise breaking down a single question into multiple parts. Performing this analysis at this point in the process helps ensure that the team is not faced with the need to backtrack within the process to clarify ambiguous hypotheses.

The third substep also involves converting the hypotheses into a data collection plan. Such a plan comprises a structured approach to collecting information required to answer the hypotheses. The team may generate a hypothesis template to formalize and memorize the decisions reached in this substep.

The fourth (4) substep completes the data collection plan by more clearly defining what is to be collected, where it is to be found, when it should be collected, and who is to perform the collection, etc.

The fifth (5) substep involves establishing an opportunity data collection plan. In other words, in the course of attempting to solve the hypotheses, the team may come across information that does not directly address the questions under consideration, but which nonetheless has a bearing and/or usefulness to the organization. This substep establishes a plan to harvest this information. Further, the team may construct a template that sets forth rules and expectations regarding the data collection process. This substep may also involve providing training regarding trend analysis (e.g. regarding the detection of trends/patterns in the collected data), and defining trending data collection procedures.

The sixth (6) substep involves defining a methodology and associated training for correlating, processing and storing information collected in the process. For instance, the process prompts the team to establish a suitable repository for archiving data collected in the process. The repository is preferably located at a central location. The use of this storage provision allows the team members to extract information from a central location without relying on the personal files maintained by any team member. Preferably, this information is archived electronically at the central site, so that appropriately authorized individuals may access this information without having to make physical copies. In one exemplary embodiment, the team correlates the collected information using a series of interrelated Quality Function Deployment (QFD) matrices, to be described in further detail below.

In an exemplary business environment, the second principal step takes approximately 1-2 weeks to complete.

By way of summary, as reflected by the initial input arrow in FIG. 1A, the first stage may receive the following input information: historic and brand market strategy information (identifying strategies applied by the organization in the past); historic target segments (identifying markets that have been targeted by the organization in the past); business vision of the organization (identifying the organization's sense of identity and objectives in the market); product/service definitions (identifying the products and/or services that the organization provides to consumers); and current strategies being applied by the organization, etc.

The output of the first or baselining stage, as reflected by the output arrow in FIG. 1C, may include: leadership sign-up (e.g., securing the support of senior leadership in the organization); assigned process team (e.g., constituting the establishment of the multi-generation process team); responsibilities and accountabilities in performance of the process; project plan; segment strategy; strategic hypotheses; data collection plan; as is SWOT analysis; prioritized strategies; opportunities collection template; basic QFD matrices for archiving information; and a cause and effect analysis output, etc.

Depending on the results of the first stage, the team may decide to recycle through selected substeps in the first, second, and/or third principal steps. Alternatively, the team may advance by proceeding to a subsequent stage.

1(c). Second Stage 1.2: Collect & Synthesize Data

1(c)(i). Overview of Second Stage

The second stage involves gathering information pertaining to emerging trends, market/environmental influences, business expectations, business capabilities, etc. The second stage also involves suggesting additional market segments and opportunities. This stage also entails performing preliminary data structuring and assessment of such data. In an exemplary embodiment, the second stage may include five principal steps and may be completed in about 8-20 weeks.

1(c)(ii). The Fourth Principal step, 1.2.1: Collect Secondary Data

The fourth principal step (identified in FIG. 1D as principal step 1.2.1) entails collecting and analyzing secondary data. That is, by way of review, at the beginning of the second stage, the team has already outlined the principal objectives and features of a data collection plan. The fourth principal step involves initiating the data collection procedure by first examining secondary data from secondary sources. Secondary data comprises previously prepared information, e.g., from public sources. For instance, exemplary secondary data may be obtained from library resources, trade publications, public market surveys and other publicly accessible market data, etc. The team looks to secondary sources first to fulfill its informational needs because such data is generally less expensive than information that is developed by the team (where such generated data is referred to as primary data herein).

The first (1) substep within the fourth principal step may involve defining data collection rules. These rules comprise guidelines for use in the data collection process. The data itself may include an assessment of the needs and values of the organization's customers (where values define what the customer considers important). Such data reflects the perspectives of the customer, thus forming Voice of the Customer (VOC) data. The collected market-related data may further include an assessment of the needs and values of intermediaries involved in the organization's business practices. An intermediary is any entity that the organization uses as an agent to market its products or services. Such data reflects the perspectives of the intermediaries, thus forming Voice of the Intermediary (VOI) data.

This substep also involves collecting various market data, such as demographic information, trends, etc. This substep also involves collecting distribution spectrum information and preferences, which define the different channels used by the organization to distribute its products and the preferences attached thereto. This substep also involves collecting information regarding competitive environment and trends, regulatory environment and trends, and general environment and trends. Information regarding the competitive environment and trends may reflect data regarding the activities and market presence of the organization's competitors. Information regarding regulatory environment and trends may reflect data regarding regulations and other constraints imposed by governmental/administrative bodies. Information regarding general environment and trends pertains generally to any other influences that have an impact on the organization (e.g., outside of a traditional regulatory impact). Generally, analysis of environment and trends gives the team a heads up regarding factors that may present obstacles to the successful deployment of a marketing solution. For example, a finding that an authority is year-by-year placing more restrictions on certain insurance products may suggest that this authority is attempting to discourage such products; this obviously has relevance to any solution that includes such products.

The second (2) substep entails documenting and evaluating the collected secondary data.

The third (3) substep entails performing a gap analysis with respect to secondary data. This substep involves identifying whether the preceding data collection operation failed to provide any sought-after information. The missing items (e.g., items that cannot be found using secondary data), are potential candidates for primary research (discussed in the subsequent two principal steps). Alternatively, the team may chose to ignore a particular informational deficiency.

The fourth (4) substep entails extracting preliminary opportunities from the data collected thus far. That is, the team determines if the data collected thus far reveals additional marketing solutions, beneficial data collection tactics, etc. (generically referred to as opportunities).

The fifth (5) substep entails storing data in the central repository (e.g., a central dedicated workroom). The use of central archiving facilitates retrieval of this information by team members, who might otherwise have to assembly this information from the personal files of multiple team members.

In the sixth (6) substep, the team begins structuring the collected data into storyboards. A storyboard is a compilation of information into a logical sequence based on one or more themes (such as regulatory, market-related, consumer demographic changes, environmental, etc.). By virtue of such compilation, the data begins to tell a story. This facilitates comprehension of the data from a high-level perspective, and, more specifically, allows team members to detect trends and gaps in the data more easily. The compilation of storyboards also facilitates communication of multi-generation ideas to senior leaders (and other individuals). The team members may use prior storyboards (constructed in prior analyses) as starting points when constructing a storyboard for a current multi-generation process.

In an exemplary business environment, the fourth principal step takes approximately 8-16 weeks to complete.

1(c)(iii). Fifth Principal Step, 1.2.2: Conduct Internal Primary Research

After extracting information from secondary sources, the team then collects primary data to further supplement its knowledge base (e.g., if such information is needed but cannot be found from less expensive secondary sources). Primary data generally comprises information that the team generates itself (or commissions others to develop). More specifically, the fifth principal step (identified in FIG. 1E as principal step 1.2.2) first attempts to collect needed data from internal primary sources. That is, in this principal step, the team first looks to its own resources to extract needed information (or, more specifically, in exemplary business settings, the team looks to information that can be obtained from resources within the organization). In one exemplary embodiment, the fifth principal step includes five substeps.

The first (1) substep entails developing a discussion guide, which serves as a model for collecting various information pertaining to the organization and its relevant environment. The information includes: business expectation information; key challenges information; criteria for performing evaluation; situation analyses; infrastructure and capability analyses (to baseline the current status of the organization); product assessment information (for as is tool analysis); promotional strategy information; pricing/profitability information; customer life-time profitability information; customer retention data information (for life-cycle planning); distribution information, etc.

The second (2) substep comprises conducting Subject Matter Expert (SME) and senior leader interviews to collect information. For instance, this step involves conducting interviews with an Information Technology (IT) SME to gain additional information regarding technical issues, and conducting interviews with an actuarial SME to gain additional information regarding actuarial issues, etc. The information thus collected may serve as input to various analytical tools used in the process, such as a GE model tool (to be described below). These interviews may be conducted on a one-on-one basis.

The second substep also involves consolidating and analyzing the information extracted from the one-on-one interviews. For instance, the team may examine the data, and on the basis thereof, formulate themes, variables, and measurements into a balanced set of criteria for use the GE model tool (to be described below).

The third (3) substep comprises documenting and evaluating the internally collected data.

The fourth (4) substep comprises performing a gap analysis with respect to the internal data to determine what information the team lacks at this stage in the analysis. In one embodiment, this step involves formulating the data into storyboards. As discussed above, the storyboards assist the team members in assessing holes (i.e., deficiencies) in the data picture.

The fifth (5) principal step comprises noting preliminary opportunities from the internal data analysis. Once again, in this substep, the team determines if the data collected thus far reveals additional marketing solutions, beneficial data collection tactics, etc. (generically referred to as opportunities).

In an exemplary business environment, the fifth principal step takes approximately 2-4 weeks to complete.

1(c)(iv). Sixth Principal Step, 1.2.3: Conduct External Primary Research

The sixth principal step (identified in FIG. 1F as principal step 1.2.3) entails conducting external primary research, if necessary. In the context used here, external research may comprise research obtained from resources that are external to the organization. For instance, the team may opt to perform a market study, a customer survey, etc. to collect addition information. The team may perform this analysis itself, or rely on one or more suppliers to furnish this information (e.g., on a contract/consulting basis). In one exemplary embodiment, the sixth principal step includes eight substeps. (As mentioned above, the team members may decide to ignore data deficiencies based on an assessment that the information is not important enough to justify the costs of obtaining it. Thus, the team may decide to completely skip this principal step.) The first (1) substep includes defining remaining data needs that may be satisfied by external primary-type research. For instance, this step may rely on the gap analysis performed in the preceding principal step to identify data deficiencies.

The second (2) substep includes identifying primary research suppliers. Such suppliers comprises individuals, organizations, etc. that have the capacity to furnish the required information.

The third (3) substep includes briefing the supplier regarding the team's informational needs. The team may rely on a template (i.e., the brief the supplier template) in performing this step. This template prompts the team to specify relevant fields of information and/or perform appropriate procedures in its communication with the supplier.

The fourth (4) substep comprises recommending a plan for interacting the selected supplier (e.g., including a procedure for collecting the information furnished by the supplier, etc.). The fifth (5) substep entails collecting the external primary data.

The sixth (6) step involves documenting and evaluating the primary data.

The seventh (7) step involves noting preliminary opportunities based on the collected external primary data.

The eighth (8) and last step involves storing the data in the central repository.

The time period required to perform the sixth principal step varies depending on the nature of the particular project and its data requirements, and the potentially unpredictable obstacles encountered in such tasks.

1(c)(v). Seventh Principal Step, 1.2.4: Combine Research Information

The seventh principal step (identified in FIG. 1G as principal step 1.2.4) involves combining and analyzing research information. In one exemplary embodiment, it includes seven substeps. The first (1) substep involves consolidating criteria for weighting and evaluation for use as metrics in the GE model (to be described below).

The second (2) substep involves developing profile summaries of the organization's target market/customer segments. As discussed above, such segments define different groups of consumers that purchase goods and services from the organization.

The third (3) substep involves creating a profile of the relevant market industry.

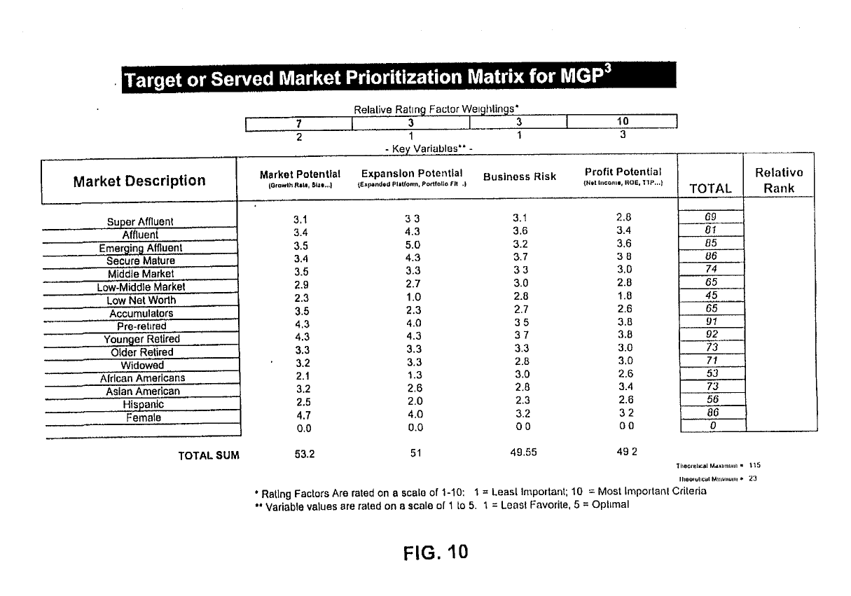

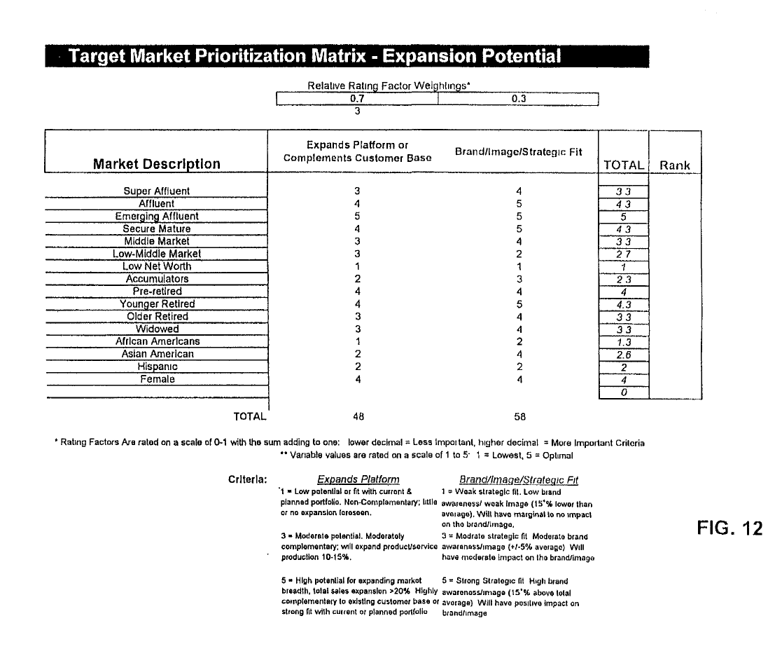

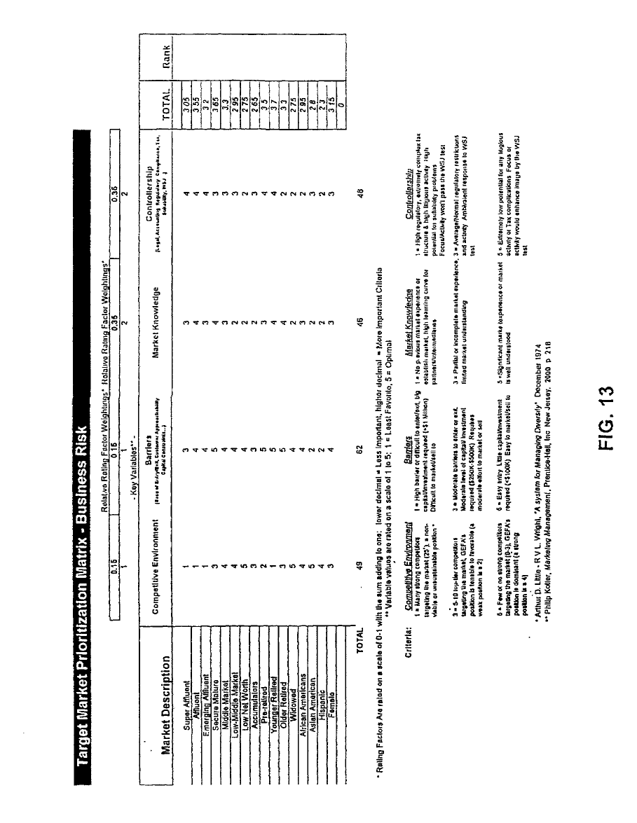

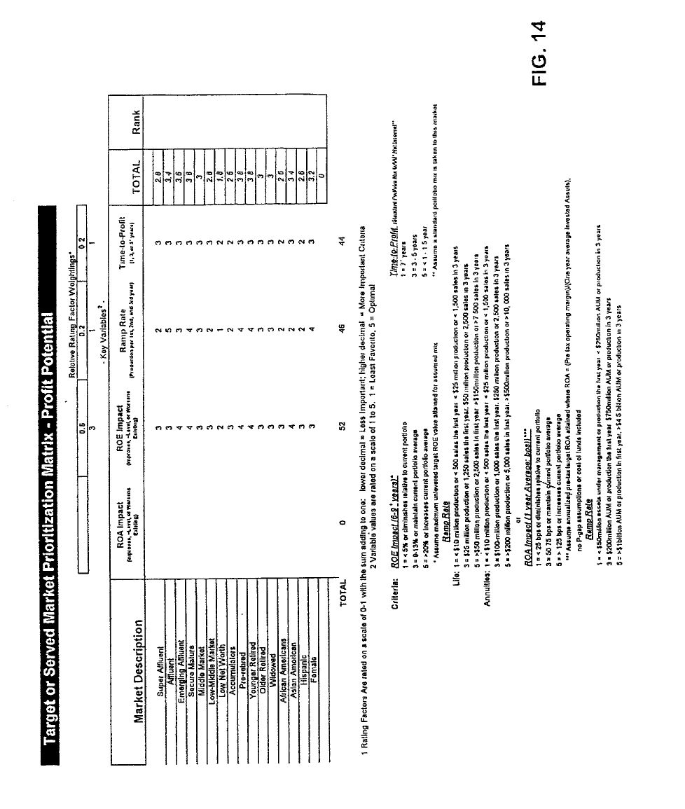

The fourth (4) substep involves prioritizing target market segments using a target market prioritization tool. For instance, the team may use a prioritization tool that is based on the same analysis approach provided by the strategy prioritization tool (used in the third principal step, as discussed above). In this application, the prioritization tool ranks the merits of different marketing segments based on a plurality of variables, sub-variables and delimiters. Section No. 3 and FIGS. 10-14 provide additional information regarding the target market prioritization tool.

In this particular substep, the team builds the prioritization tool based on data that reflects the prevailing sales activity of the organization (thus forming an as is analysis). Such an as is analysis provides a means for calibrating and validating the tool before it is applied in a speculative/projective capacity (e.g., before it is applied to a should be or what if problem).

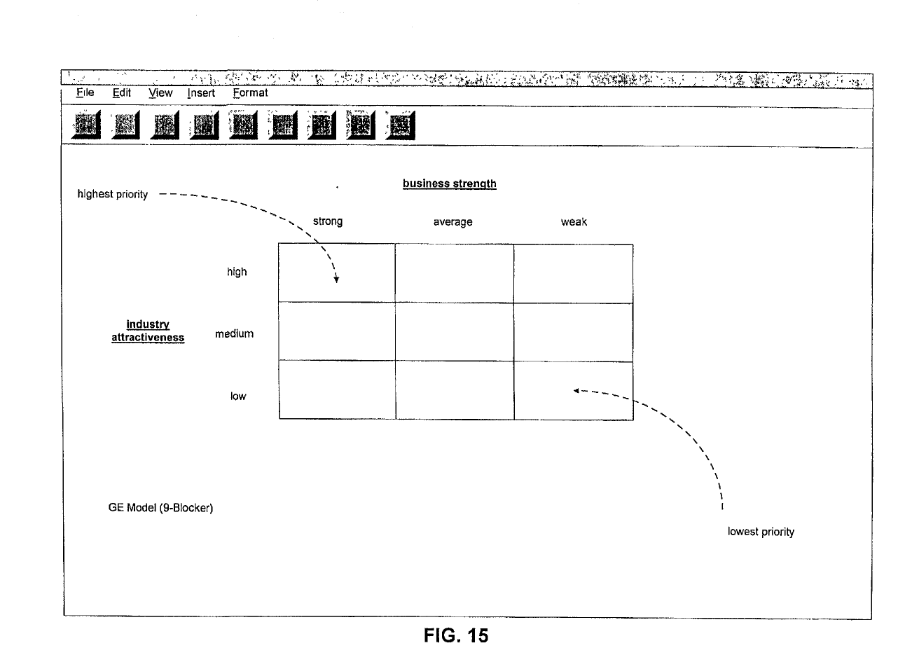

The fifth (5) substep involves building an as is company strategy using an appropriate analysis tool, such as an as is GE model. FIG. 15 illustrates the basic approach used by the GE model. As indicated there, the vertical y axis quantities industry attractiveness into low, medium, and high values. Industry or market attractiveness may depend on multiple factors, such as market growth, pricing, market diversity, competitive structure, technical role, social impact, profitability, environmental impact, etc. The horizontal axis x quantifies business strength into strong, average, and weak. Business strength may also depend on multiple factors, such as market position, margin, technology position, size, growth potential, environmental record, etc. The two axes, each divided into three gradations, define nine different permutations of criteria within the grid itself. As such, the GE model is also referred to as a 9-Blocker tool (or in a more general case, a multi-blocker tool).

In operation, the team assesses the respective attractiveness and strengths of the products and services in the organization's portfolio, and then places the products and services at appropriate locations on the grid as a function of such assessment. The positions of the products and services on the grid thus clearly convey the relative merits of different business solutions. That is, products and services placed in the upper left quadrant of the model generally define solutions having high priority/value. Products and services placed in the lower right quadrant generally define solutions having low priority/value. Products and services positioned in other regions of the model have negotiable or intermediate value.

The fifth substep particularly involves applying the GE model to make an as is assessment of the organization, e.g., based on an assessment of the existing products and services provided by the organization. The as is GE model provides a technique for gaining insight into the relative merits of the organization's current portfolio. Further, application of non-speculative data to this tool allows the team to test and validate the tool before application to new solutions in the context of what if analysis. In other words, the team may first apply the model to existing products to determine if the results makes sense when compared with various objective criteria that may be available to the team based on the organization's actual business practices.

The fifth substep may also involve building a financial package using various tools, such as bubble charts, funding plans (3-5 year expense allocation histograms), profitability projections, etc. Bubble charts comprise tools that show the quantity of different products and services sold using a proportionately sized bubble placed on a chart. The user places the bubbles on the chart at locations representative of the products” respective returns on equity.

The sixth (6) substep involves inputting information into a Quality Function Deployment (QFD) analysis tool. QFD analysis identifies how various features of the organization correlate with each other. More specifically, an exemplary QFD tool may comprise a series of interrelated matrices. A first matrix may include axes respectively identifying properties A and B, and may present information within the matrix relevant to different values (or aspects) of these two properties. A second matrix may include axes respectively identifying properties B and C, and may present information within the matrix relevant to different values (or aspects) of these two properties. A third, fourth, fifth, etc. matrices may include yet further interrelated properties. In an exemplary context contemplated by the present invention, the matrices may prevent information which interrelates market-related information with product-related information. Hence, in use, a user may select any piece of information in any matrix, and then drill down or drill up in the series of interrelated matrices to identify how this information relates to and potentially impacts other fields of information. This tool thus provides a powerful multi-dimensional information space in which to navigate through the linked information, and in the process, gain new insights regarding the organization's business environment.

In an alternative embodiment, the team may decide to omit QFD analysis based on an assessment that the costs of performing this analysis outweigh its benefit (e.g., the team may regard this step as too time-intensive and costly).

If developed, the seventh (7) substep involves performing strategic opportunity assessment using the QFD tool identified above.

The eighth (8) substep involves validating the level of QFD detail associated with target segmentation and products and services, e.g., to determine whether the selected QFD properties have an appropriate level of granularity to provide useful results. For example, the team may seek to clarify whether a target segment identifying a certain ethnic group should be further broken down into individual subgroups within that group.

The ninth substep involves matching needs through a Critical To Quality (CTQ) tree. This tool provides a graphical technique for identifying factors in a solution that are deemed relatively important to the success of the solution.

In an exemplary business environment, the seventh principal step takes approximately 2-4 weeks to complete.

1(c)(vi): Eighth Principal Step, 1.2.5. Identify and Assess Opportunities

The eighth principal step (identified in FIG. 1H as principal step 1.2.5) involves identifying and assessing opportunities. An opportunity may comprise a new market that the organization may wish to target, a product or service that the organization may wish to develop, a new channel that the organization may wish to exploit or introduce, etc. In one exemplary embodiment, this principal step includes ten substeps. The first (1) substep involves brainstorming to identify potential opportunities. In this substep, the team also examines the data in aggregate to determine if the combined data reveals additional opportunities that were previously unrecognized based on less comprehensive groupings of the data. Such opportunities are referred to as aggregate opportunities.

The first substep also involves validating the above-identified potential opportunities with individual business subject matter experts (SMEs). That is, once the team has generated ideas regarding new business opportunities, this substep prompts the team to first validate these ideas by presenting them to appropriate SMEs (such as appropriate experts employed by the organization). The SMEs may then comment of the speculated strengths and weakness of the solutions based on, for instance, their general knowledge gained through years of experience in the relevant fields. The involvement of SMEs at this stage in the process provides a useful low-cost/low-profile validation test before the ideas are shopped to higher-level recipients, such as senior leaders in the organization.

The second (2) substep involves building respective strategies for identified products and services. This may be performed by building a what if GE model (e.g., as opposed to the previously discussed as is GE model). At this point, the GE model (with its associated criteria) has been validated based on the as is analysis.

The third (3) substep may involve building a strategy for service and distribution, using, for instance, a GE Model tool (to be described in greater detail below) for providing a what if service and distribution assessment. This tool is particularly useful in those cases where distribution is a key component in the distribution of a product.

The fourth (4) substep involves building and using various tools to assess the desirability of identified solutions, including various ease of implementation tools, a risk versus newness tool, and various economic profiling tools. Section No. 3 (below) describes exemplary tools that may be used in performing this substep.

The fifth (5) substep involves building a straw man product and service prioritization from prioritization criteria. This tool may comprise, for instance, a page in the story board which summarizes the team's proposed solutions. This analysis is referred to as straw man analysis because it provides a convenient format for framing and focusing discussion with the senior leadership, e.g., regarding ordering of tasks and the derivation of priorities.

The sixth (6) substep involves analyzing a present solution using, for instance, a what if business positioning strategy tool. An Ansoff-type tool may be used to perform this analysis. Section No. 3 describes the Ansoff tool.

The seventh (7) substep involves refining the strategic opportunity assessment using QFD and/or collecting additional data.

The eighth (8) substep involves building a radar positional chart to provide further assessment of solutions. This tool allows the team to examine the gap that separates the organization's current position and the organization's target position (e.g., the position that the organization aims to achieve). Section No. 3 below describes this tool in greater detail.

The ninth (9) substep involves further refining the storyboards based on the above-defined analysis. More specifically, this substep involves refining the storyboards so that they are sufficient to present to the senior leadership in the next stage.

The tenth (10) substep involves storing newly-obtained information in the central repositoryln an exemplary embodiment, the eighth principal step may take approximately 2-3 weeks to complete.

The general output of the second stage includes various structured data, including: general market data; segmented data; company verses market data baseline information; industry data and trends; competitive data and trends; VOC data; VOI data; and environmental trends. The second stage also generates a preliminary list of solutions, as conveyed by: various tool outputs, exit and entry suggestions, etc.

Following the completion of the second stage, the team may opt to revise its hypotheses and segmentation analysis, and thus repeat one or more steps in the second stage. Alternatively, if the team is satisfied with its analysis results thus far, it may opt to advance to the third stage, which involves the presentation of various solutions to senior leaders in a strategic workout session.

1(d). Third Basic Stage: Develop Business Strategy

1(d)(i). Overview of Third Basic Stage

As stated, the third basic stage includes conducting a strategic work out, in which the team presents its findings (e.g., as conveyed by the storyboards generated in prior analyses) to the senior leaders (during, for instance, a day-long meeting with the senior leaders). The strategic workout may involve developing, bundling and prioritizing solutions, and also creating consensus regarding the high-level strategy to be used. In one exemplary embodiment, the entire stage may include three principal steps that may be completed in about 2-6 weeks.

1(d)(ii). Ninth Principal Step, 1.3.1: Review and Generate Opportunities

The ninth principal step (identified in FIG. 1i as principal step 1.3.1) entails reviewing and generating opportunities. In one exemplary embodiment, this principal step includes eight substeps. The first (1) substep of this principal step involves reviewing the market-industry profile that was developed in prior steps.

The second (2) substep involves reaching consensus with respect to target segments. That is, in this substep, the team queries the leaders regarding whether the identified target markets are appropriate.

The third (3) substep involves reviewing the as is strategy for each product and service (e.g., using the as is GE model tool). That is, in this substep, the team discusses the current business strategies employed by the organization with respect to identified products and services.

The fourth (4) substep involves reviewing radar positional chart analysis. This allows the leaders to view the team's should be recommendations vis-a-vis the as is status of the organization.

The fifth (5) substep involves reviewing the should be strategy for each product and service (e.g., using the should be GE model tool). In this step, the team discusses the business strategies that the organization may adopt to gain identified benefits.

The sixth (6) substep involves generating additional opportunities by session brainstorming. More specifically, the senior leaders may constitute a highly engaged audience because the information being presented to them effectively answers their questions and concerns initially raised in the kickoff session. Further, the storyboards are expected to provide significant new market insight. As such, the senior leaders may be expected to asks questions, make suggestions, raise additional concerns, etc. The sixth substep involves harvesting this additional formation in an interactive fashion for its potential use in generating additional opportunities for presenting effective business solutions.

The seventh (7) substep involves adding opportunities (such as the additional opportunities identified above) to the should be strategy, using, for instance, the should be GE model tool.

The eighth (8) substep involves agreeing on a final GE model analysis.

In one exemplary embodiment, the ninth principal step may be completed in about 0.5 to 1 day (e.g., in a meeting with senior leaders that lasts this amount of time).

1(d)(iii). Tenth Principal Step, 1.3.2: Assess and Prioritize Opportunities

The tenth principal step (identified in FIG. 1J as principal step 1.3.2) involves assessing and prioritizing opportunities. In one exemplary embodiment, this principal step includes five substeps. The first (1) substep involves agreeing on criteria for prioritizing the product, services and distribution opportunities. This step may involve weighing ease of implementation considerations with respect to importance considerations and economic profile considerations. [?]The second (2) substep involves reprioritizing the products, services and distribution opportunities.

The third (3) substep involves adding lead opportunities to the business strategy tool. For example, the team may use the so-called Ansoff model to perform this analysis.

The fourth (4) substep involves reaffirming the strategic business vision of the organization. In other words, this step involves determining whether the organization's vision (e.g., conception of its role in the market) is consistent with its actual business practices and position in the market. In fact, there may be disconnect between a business” activities in the market and its own conception of its role in the market, creating a resultant dissonance.

The fifth (5) substep involves developing a rough timeline for implementing the business solution. For instance, the team may rely on a GANTT format to perform this high-level planning. GANTT analysis may identify roll-out priority timeframes for performing various activities. The GANTT analysis may also identify timeframes for which various resources will be required. Typical GANTT analysis presents such timeframe information using an arrayed series of bars. The start of an exemplary bar indicates the commencement of an associated timeframe, and the end of such bar indicates the completion of the associated timeframe. The length of such bar graphically indicates the length of the timeframe. Section No. 3 (below) presents additional information regarding the GANTT tool.

In one exemplary embodiment, the ninth principal step may be completed in about 0.5 to 1 day.

1(d)(iv). Eleventh Principal Step, 1.3.4: Develop High Level Plan, 1.3.4 (Team-Post Work-Out)

Having now secured the consensus of the senior leaders regarding strategic issues (in the prior two principal steps), the team begins to turn its attention to execution issues. As such, the eleventh principal step (identified in FIG. 1K as principal step 1.3.4) involves developing a high level plan for carrying out the marketing solutions. In one embodiment, it includes twelve substeps. The first (1) substep entails affirming the vision and mission of the organization.

The second (2) substep involves revisiting the timeline developed in the previous principal step to make any additions, deletions, changes, etc. as deemed appropriate.

The third (3) substep involves determining the resources necessary to implement the agreed-upon marketing solutions.

The fourth (4) substep involves reviewing and confirming infrastructure growth plans. This substep involves ascertaining the manner in which the organization is likely to grow (or otherwise change).

The fifth (5) substep entails matching current infrastructure capability to the growth plans reviewed above, e.g., to ensure that the organization will continue to have the resources to implement the marketing solutions as it grows (or otherwise changes).

The sixth (6) substep involves reviewing and confirming organizational structure. This substep also involves ensuring that that organization's current resources are sufficient to implement the identified solutions.

The seventh (7) substep involves reviewing and confirming financial budgets that govern the organization. This step involves determining whether the organization is in a position to adequately fund the identified business solutions.

The eighth (8) substep involves tying the implementation plans to the short term financial evolution of the organization (e.g., the organization's projected 3-5 year evolution) to ensure that the implementation plans are compatible with the financial evolution.

The ninth (9) substep involves performing gap assessment with respect to implementation issues.

The tenth (10) substep involves developing strategies for providing the solution. This substep involves exploring the various purchasing, building, investing, and/or sourcing requirements of the solution. This substep may also involving defining an appropriate exit strategy for terminating the solution.

The eleventh (11) substep involves developing one or more high-level tactical GANTT charts for implementing the solution.

The twelfth (12) substep involves reviewing and confirming the organization's strategic vision. This substep ensures that the process still adequately reflects the basic objectives articulated by the senior leaders.

In one exemplary business environment, the eleventh principal step may be completed in about 2-6 weeks.

In summary, exemplary output of the third stage includes: prioritized opportunities; sourcing/partnering strategies; high level tactical GANTT chart(s); senior leader consensus and high-level plan commitments; business strategy and vision affirmation; basic infrastructure plans; basic funding budget plans; and a preliminary gap assessment.

1(e). Fourth Basic Stage, 1.4: Develop Implementation Plan (Tactical Work-Out)

1(e)(i). Overview of Fourth Basic Stage

The fourth basic stage entails refining and finalizing the implementation (roll out) plan. This stage also involves developing measurements of success for use in evaluating the success of the implementation. In one exemplary embodiment, the fourth stage includes three principal steps and may be performed in 1-4 weeks.

1(e)(ii). Twelfth Principal Step, 4.1.1: Develop Measurement System and Assess Risks

The twelfth principal step (identified in FIG. 1L as principal step 1.4.1) involves developing a measurement system and assessing risks. In one exemplary embodiment, this step may be performed in nine substeps. The first (1), second (2), and third (3) substeps involve finalizing the product and services plan, resource plan, and infrastructure plan, respectively. A product and services plan identifies products and services that will be delivered as part of the marketing solution. A resource plan identifies resources that will be used in providing the marketing solution. An infrastructure plan identifies the infrastructure that will be utilized in providing the marketing solution.

The fourth (4) substep involves finalizing a sourcing/partnering plan. In this substep, the team determines whether the organization will provide the marketing solution using its internal resources. If not, the team identifies the entity that will provide this solution, and will identify/address the steps necessary to set up this entity as a partner.

The fifth (5) and sixth (6) substeps involve determining marketing goals and finalizing the marketing plan, respectively. A marketing plan identifies the approach that the organization has selected to provide products and/or services to identified market segments.

The seventh (7) substep involves developing a contingency plan or exit strategy. In this step, the team identifies procedures for addressing problems that may occur in providing the solution (such as procedures for terminating a project, or modifying an unsuccessful project).

The eighth (8) substep involves finalizing the tactical GANTT chart. As previously described, the GANTT chart defines the timeline for completing identified actions in the course of implementing the solution.

The ninth (9) substep involves reaffirming and setting business expense budgets for the solution. This step ensures that the organization's budget accommodates the expenditures required by the solution.

In one exemplary business setting, this step may be performed in 0.5 to 1 days.

1(e)(iii). Thirteenth Principal Step, 1.4.2: Communicate Plan

The thirteenth principal step (identified in FIG. 1M as principal step 1.4.2) involves communicating the plan. In one exemplary embodiment, this principal step includes four substeps. The first (1) substep involves developing growth measures and financial goals. This step basically involves establishing criteria (benchmarks) for assessing the success of the solution.

The second (2) substep involves developing financial projections that identify estimated financial success of selected products and services. In one exemplary case, the team may provide projections for about 5-10 of the organization's leading products.

The third (3) substep involves performing final gap assessment. Final gap assessment involves reviewing the current status of the process against expectations/requirements, to identify any deficiencies.

The fourth (4) substep involves performing high-level risk assessment with respect to the solution. For instance, the team may use Failure Mode and Effects Analysis (FMEA) to perform this substep. FMEA analysis identifies failure modes (risks) facing business solutions, potential effects of the failures, severity of the failures, potential causes of the failures, relative occurrences of the failures, current controls and/or mitigants which may offset the effects of the failures, detectability of the failures, and recommended procedures to address the failures. In alternative embodiments, the team may decide to forego FMEA analysis because its cost is assessed to be too high compared to its projected benefits.

In one exemplary business setting, the thirteenth principal step may be performed in 0.5-1 day.

1(e)(iv). Fourteenth Principal Step, 1.4.3: Develop Detailed Action Plans

The fourteenth principal step (identified in FIG. 1N as principal step 1.4.3) involves developing detailed action plans to implement the solution. In one exemplary embodiment, this principal step includes six substeps. The first (1) substep involves formatting the multi-generation package, including all documentation generated by the process. The team performs this substep by assembling the output of the process into a coherent body of information, e.g., to facilitate referencing of this information in the future.

The second (2) substep involves documenting lessons learned in the course of performing the process. For instance, this step may involve identifying the procedures and tools that were particularly successful, and those that were particularly problematic or unproductive, etc.

The third (3) substep entails developing a Change Acceleration Process (CAP) model and communication plan. The CAP tool provides techniques which facilitate the introduction of change within the organization. More specifically, this tool allows proponents of change in the organization to identify potential obstacles to change (e.g., from a personnel/psychological standpoint). Further, this tool provides suggestions as to how the proponents might overcome these obstacles.

A team may choose to apply this tool, for instance, if the solution causes substantial change in the organization.

The fourth (4) substep entails providing output from the multi-generation process to relevant parties in the organization, to ensure that they are apprised of their role in bringing the solution to fruition. The team may perform Ansoff model analysis in this step.

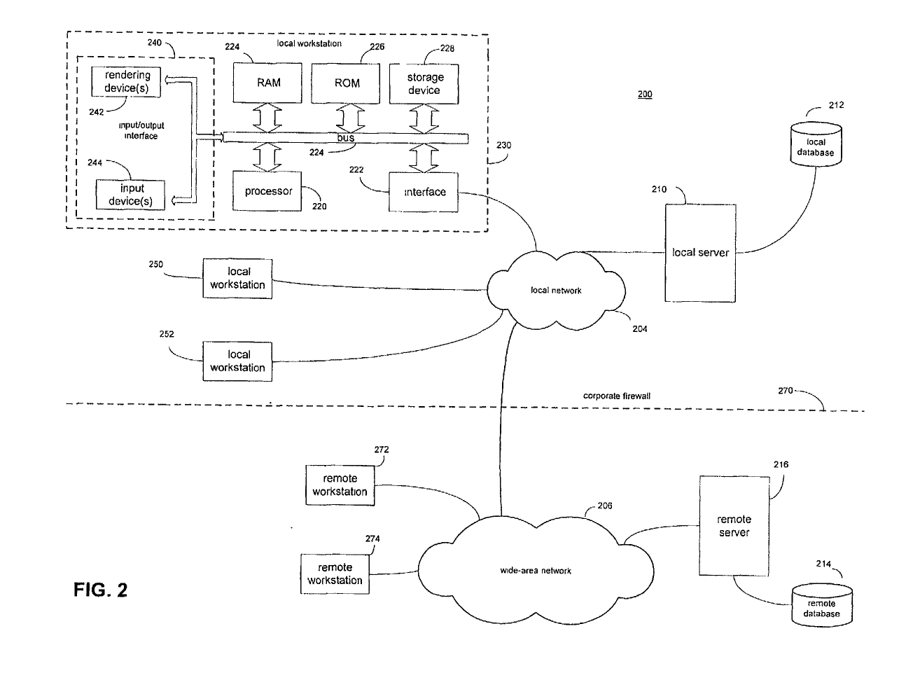

The fifth (5) substep entails storing appropriate results in the central repository. The organization may also authorize storage of such data on a network-accessible database (to be described below with reference to FIG. 2) so that other authorized business entities may access and use the data.

The sixth (6) substep involves identifying various follow-up tasks and assigning responsibility for these actions. For instance, the team may provide for the repetition of certain tasks in the process, as prescribed by an identified renewal or refinement process.

In one exemplary business setting, the fourteenth principal step may be performed in 0.5 to 1 days.

The output of the fourteenth principal step may include: product and service plans; detailed rollout plans; resource plans; infrastructure plans; sourcing/partnering plans; marketing plans; growth and success measures; contingency/exit strategy plans; communication plans; and the multi-generation package including all documentation from the process. The ultimate output of the process includes the various outputs identified in the preceding discussion, including: identified target market segments for potential exploitation; business positioning information; business vision (validated hypotheses) and mission information; various tool outputs (such as prioritized strategies), markets, products and services, roll-out plans, various archive outputs, storyboards, etc.

The completion of the fourteenth principal step may not terminate the multi-generation process. For instance, in an on-going effort to improve results, the team (or other accountable individuals) may repeat certain steps in the process. For instance, the team may choose to perform, on an needed basis, supplemental analysis when new product/service opportunities arise for prioritization. The team may also develop or refine success criteria, the tactical GANTT chart, etc. The team may also periodically communicate results throughout the organization, and periodically archive information as needed.

The output of the process may also serve as input to other tools. For instance, various other tools may be used to execute and operationalize the solutions generated by the multi-generation process. One such tool is described in commonly assigned U.S. application Ser. No. 09/293,398, filed on Apr. 16, 1999, and in commonly assigned U.S. application Ser. No. 09/475,693, filed on Dec. 31, 1999, both entitled System and Method for Developing and Managing a Financial Service Product. Both of these applications are incorporated herein by reference in their respective entireties. (The multi-generation tool may collect some of the information solicited by the tool described in the above-identified applications, such as market data).

In summary, the above-described process applies a highly structured approach to performing business planning. This improves the efficiency of the process and potentially reduces the chances of its failure. Further, the analysis performed in the multi-generation process uses a cross-functional approach, involving personnel having different expertise, insights, and decision-making authority. This ensures that decisions do not evolve within an isolated department within the organization, ignorant of the needs and expectations of other departments and senior leadership. The multi-generation process also departs from the known systems by interspersing tactical considerations within its strategic analysis. This helps ensure that the strategic planning does not ignore the limitations and strengths of the tactical infrastructure of the organization. In this sense the multi-generation process may be said to connect the front end of the planning process to its back end.

2. Exemplary Implementation of the Process

The above-described process can be implemented in various ways. In general terms, the process is implemented by supplying a user (such a member of a business planning team) with a marketing package or kit. This package or kit comprises information that describes the structured process, such as information that identifies the principal steps and substeps within the process. The kit also comprises a collection of tools for potential use in performing the process. In operation, the user accesses the information and then performs the process specified in the retrieved information. The user may access and utilize the tools when prompted to do so by the process.

More specifically, in a fully manual mode of operation, the kit may represent a hard-copy depiction of the process and tools. The user may physically access the kit, and distribute it to team members (and other need to know individuals). Thereafter, the members reference and utilize the hard-copy depictions when performing the process.

In an electronic mode of operation, the kit may comprise a digital representation of the process and tools. Such information may represent separate digital documents, or may represent an integrated software package including multiple functional modules and navigational mechanisms for sequencing from one module to another. The user may electronically access information regarding the process and tools from an appropriate electronic repository of such information, and then perform the process by making reference to such information (e.g., by making reference to a display of such information/tools on a computer monitor or like presentation device, or by printing such information out and utilizing the print-out for guidance). Further, in the electronic model, processing devices (such as computer workstations) may be configured to automate selected aspects of the kit, such as various analysis and computations performed by the tools. Further, in the electronic model, users may electronically communicate with each other to facilitate performing the process.

Those having skill in the art will appreciate that there are additional ways of implementing the invention, such as embodiments that combine, in hybrid fashion, aspects of the above-described manual and electronic implementations.

FIGS. 2 et seq. describes an exemplary system 200 for implementing the invention using an electronic implementation model. System 200 includes a computer 230. Computer 230 represents any type of general or special purpose computer including conventional hardware, such as a processor 220 connected, via bus 223, to a RAM memory (Random Access Memory) 224, ROM memory (Read-Only Memory) 226, storage device 228, processor 220, and communication interface 222. The processor 220 can comprise any type of microprocessor or other logic-executing unit (and may further execute instructions specified by any type of operating system program, such as Microsoft Windows™, etc.). The storage device 228 may comprise any type of storage media, such as any type of magnetic or optical media (e.g., CDROM). The computer further includes an input/output interface unit 240. The interface unit 240 may include one or more input devices 244 for use in inputting information to the workstation (e.g., using a keyboard, touch-sensitive panel or screen, speech recognition input, etc.). The interface unit 240 may also include one or more rendering devices 242 for presenting information to a user (e.g., using a display, printer, audio output, etc.). For instance, the rendering device(s) 242 may comprise a display for displaying information pertaining to the principal steps and substeps in the process, as well as various tools for use in performing the process.

Various other types of workstations or terminals can be used to interact with the system 200. For example, the workstation can be embodied as any type of wireless mobile station (e.g., having Internet browsing capability), a Palm type of processing device (e.g., a Personal Digital Assistant), etc.

One or more networks may connect workstation 230 with other devices. For instance, in the exemplary embodiment of FIG. 2, a local network 204 connects workstation 230 with various other local workstations (e.g., workstations 250 and 252). The local network 204 may also connect workstation 230 with one or more local servers and associated local databases (such as local server 210 and associated local database 212). In one exemplary embodiment, the local network may comprise a local intranet network that connects workstations affiliated with an organization, such as a corporation. Firewall 270 may protect data and resources maintained by the organization from unauthorized intrusion and/or corruption by external entities.

In addition, a wide area network 206 may connect workstation 230 with various remote workstations (such as workstations 272 and 274). The wide area network 206 may also connect workstation 230 with one or more remote servers and associated remote databases (such as remote server 216 and associated remote database 214). In one exemplary embodiment, the local network may comprise the Internet or other network having connectivity outside the organization's infrastructure.

The networks 204 and 206 can be physically implemented as one or more hardwired links, and/or one or more wireless links. Further, the links used in the networks 204 and 206 may operate using a variety of known network enabling code, such as Hypertext Markup Language (HTML) or Extensible Markup Language (XML), etc. The databases 212 and 214 may be implemented as Oracle™ relational databases sold commercially by Oracle Corp. Other database protocols can be used to implement the databases, such as Informix™, DB2 (Database 2), Sybase, etc. Further, the databases 212 and 214 may comprise a unified storage repository located at a single site, or may represent multiple repositories coupled together in distributed fashion.

In one implementation embodiment, the local memory of the workstation 230 (e.g., as stored in storage device 228) stores the market planning kit (comprising information that describes the process, as well as the tool set for use in performing the process). In another implementation embodiment, the local database 212 stores the kit. In another embodiment, remote database 214 stores the kit. In still another implementations, data defining the kit is distributed across multiple databases, such as within local memory of workstation 230, local database 212, and/or remote database 214.

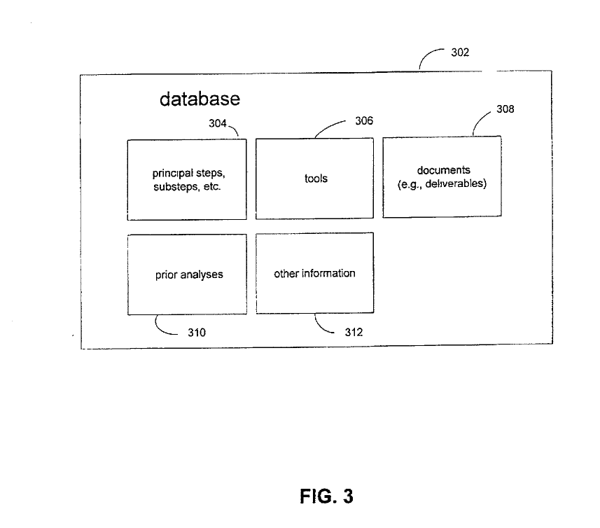

FIG. 3 shows database 302 that may be stored in any of the above-identified repositories, or in some other repository. The database 302 includes a first information file 304 that includes data that identifies the principal steps, component steps (e.g., substeps), and other information pertaining to the multi-generation process. The database 302 also includes a second information file 306 that identifies the tools that can be used to perform analysis associated with each principal step and substep. The tools file 306 may contain merely a link to another storage location that stores the actual tools, or may contain the software code to implement the tools. As noted in section No. 1, the tools may include a series of worksheets used to perform analysis associated with various principal steps and substeps. The tools may also include other software programs to perform financial analysis, to access information, or to communicate with other computers. The database 302 may also include a third information file 308 that stores deliverables (e.g., documents) produced by the process. The database 302 may also include a fourth file 310 that contains information that identifies previous multi-generation projects initiated by the organization. Product providers may access this file 310 and extract any relevant resources that may be of use in administering a current project. Finally, the database 302 may include various other files 312 as deemed appropriate to particular applications.

Each of the files 304, 306, 308, 310, and 312 may form distinct units of information having separate addresses. Alternatively, these information files may represent merely separate information fields in a single addressable file. In either case, information stored in the five files is preferably cross-indexed to indicate how one field of information corresponds to other fields. For instance, the database preferably indicates the correspondence between the steps in file 304 and the tools in file 306 that are used in each of the steps.

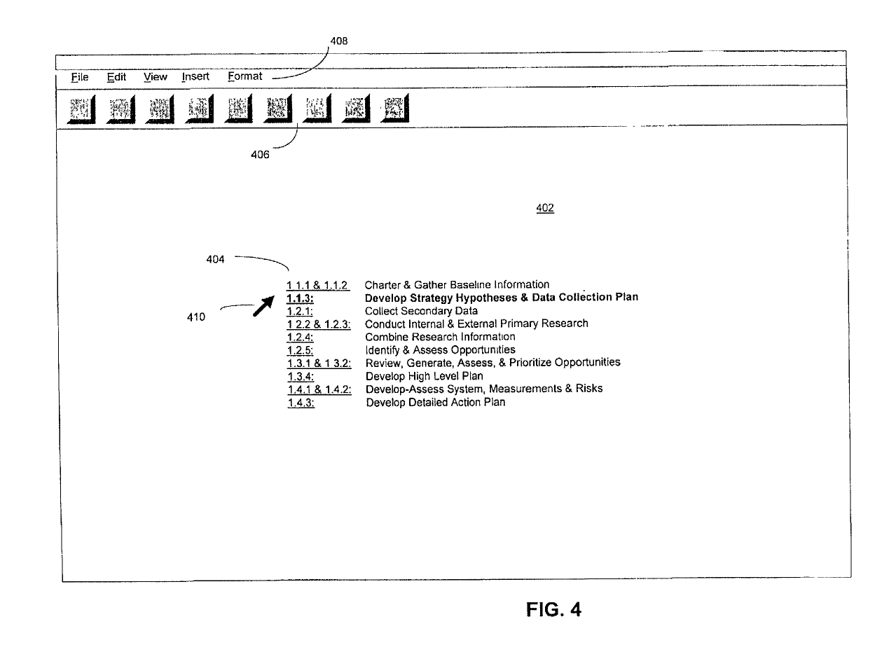

FIGS. 4 et seq. illustrates an exemplary computer interface allowing a user to access the process information and perform the steps in the process. FIG. 4 shows an exemplary main (initial) page or screen. The page may comprise conventional graphic interface components, such as a main display section 402, a tool bar 406, and a menu bar 408. The main display section 402 includes a listing 404 of the principal steps in the process, namely: (1.1.1 & 1.1.2) Charter & Gather Baseline Information; (1.1.3) Develop Strategy Hypotheses & Data Collection Plan; (1.2.1) Collect Secondary Data; (1.2.2 & 1.2.3) Conduct Internal & External Primary Research; (1.2.4) Combine Research Information; (1.2.5) Identify & Assess Opportunities; (1.3.1 & 1.3.2) Review, Generate, Assess, & Prioritize Opportunities; (1.3.4) Develop High Level Plan; (1.4.1 & 1.4.2) Develop-Assess System, Measurements & Risks; and (1.4.3) Develop Detailed Action Plan.

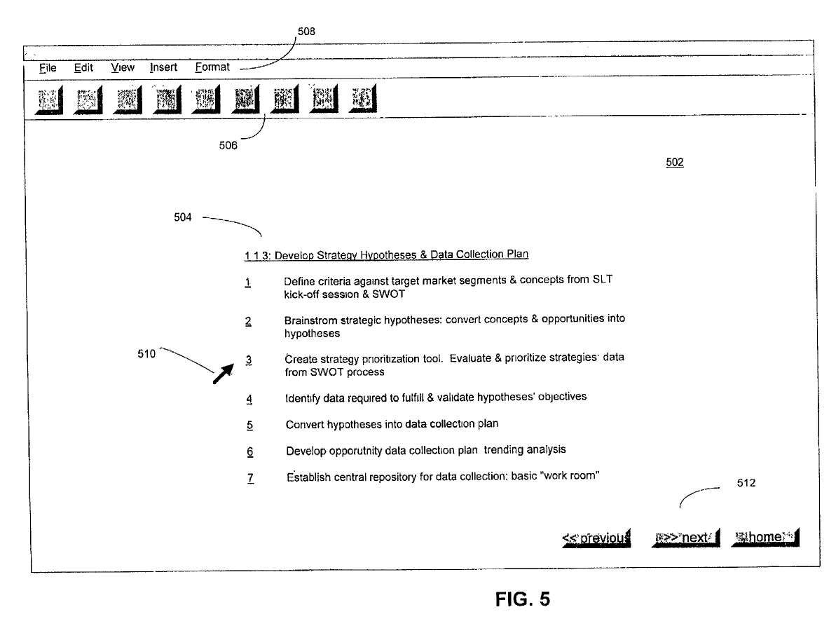

Each principal step entry in the listing may include a stored link (e.g., a hypertext link) that associates each principal step with a respective sub-page that lists its component substeps. For instance, activating the link for the principal steps 1.1.3 (Develop Strategy Hypotheses & Data Collection Plan) will cause the display of a sub-page describing the second principal step. An example of this page is shown in FIG. 5 (to be discussed below). A link may be activated in a conventional manner, e.g., by clicking on the appropriate principal step text in FIG. 4 (e.g., note the cursor symbol 410 positioned on the principal step 1.1.3).

The tool bar 406 may contain various groupings of icons which serve different functions. A first icon group may be used for accessing and storing information relating to the process. For instance, an exemplary icon in this group may allow the user to access project files pertaining to current and prior multi-generation analyses.

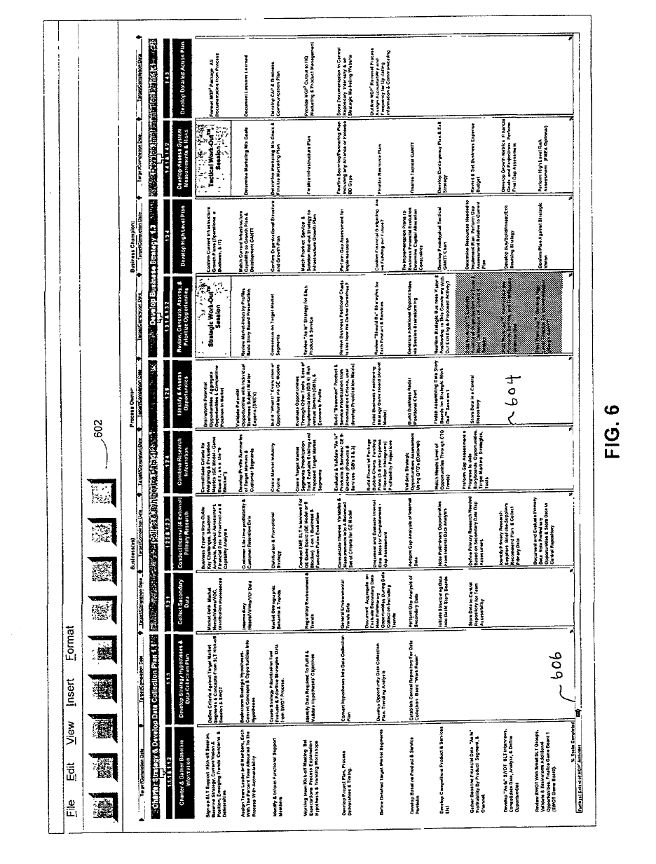

The tool bar 406 may also include a second icon group for accessing various tools used in performing the process. For instance, an exemplary icon in this group may allow the user to access a software-scheduling tool. The scheduling tool may allocate events in the process into timeslots, provide a detailed summary of the status of each step (including percent completed, duration, starting date, etc.), provide audible and/or visual reminders, etc. In one example, the Microsoft Project Plan Ô program can be used. Other exemplary icons in this group may activate the tools identified in the right column of FIG. 1. Another exemplary icon in this group may allow a user to access a thermometer chart, which shows the team's process in completing the tasks defined by the multi-generation process. FIG. 6, discussed in further detail below, shows an exemplary thermometer chart.

The tool bar 406 also may include a third icon group devoted to communication options. For instance, an icon in this group may allow the user to initiate a meeting between individuals involved in the process. For instance, a first project participant can use computer 230 (with reference to FIG. 1) to conduct a meeting with another project participant who is using computer 250 (with reference to FIG. 1) by activating a conferencing icon. In connection therewith, the system 200 (of FIG. 2) may group users into multiple user groups having different information access privileges associated therewith. The system may include centrally located information (e.g., stored in databases 212 or 216) that determines the user group of any user that seeks to access information (e.g., by comparing the user's input password against a table that maps passwords and user group affiliations). The system 200 would then present a specific subset of information resources (and, if so configured, a different graphical selection of options) to the user depending on the user's assessed user group affiliation.

FIG. 5, as mentioned above, identifies the substeps 504 in a principal step (e.g., in this case, the substeps in the principal step 1.1.3). It is accessed by activating the link associated with this principal step as listed in FIG. 4. The substeps include: (1) Define criteria against target market segments & concepts from SLT; (2) Kick-off session & SWOT; (3) Brainstorm strategic hypotheses: convert concepts & opportunities into hypotheses; (3) Create strategy prioritization tool; (4) Evaluate & prioritize strategies: data from SWOT process; (4) Identify data required to fulfill & validate hypotheses” objectives; (5) Convert hypotheses into data collection plan; (6) Develop opportunity data collection plan: trending analysis; and (7) Establish central repository for data collection: basic work room. Each of these substeps, in turn, comprises a link to further information regarding the activated substep. For instance, activating a substep link can access one or more worksheets that assist the user in performing the substep, or if so configured, may access detailed textual instructions regarding the substep.

The page shown in FIG. 5 also provides a group of tool icons 506. These tool icons can comprise the same tool icons identified in FIG. 4. Preferably, tool icons 506 also provide access to specific tools useful in performing the principal step being displayed. For example, the worksheet icons presented in the context of FIG. 5 would preferably include icons representing analyses particularly appropriate for performing the substeps within principal step 1.1.3. The memory database (see FIG. 3) provides the relational links to provide this type of association between steps, deliverables, tools, and other information.

Finally, FIG. 5 includes well known navigation buttons 512 to access the previously accessed page (previous), the next screen in a stored series of screens (next), and the original screen shown in FIG. 4 (home).

FIG. 6 provides a detailed process status screen (otherwise known as a thermometer screen or thermometer chart), which can be accessed by, for instance, activating a thermometer icon in a prior page. The columns in this chart represent principal steps in the process (or, in some cases, groupings of principal steps). A horizontal and/or vertical scroll bars (not shown) may be added to this screen to allow the user to respectively adjust the horizontal and vertical positions of the chart on the page (e.g., for those projects in which the chart does not fit on one page).

The substeps appear beneath their respective principal step legends (these substeps were discussed in connection with FIG. 1). Further, the chart presents thermometers that vertically extend beneath respective principal step legends. For example, thermometer 604 extends vertically beneath the column corresponding to the principal step 1.2.4 (Combine Research Information). The thermometer can indicate the level of completion of a principal step by successively changing the color (or gray scale) of the thermometer to simulate the rising of the level of fluid in an actual thermometer. That is, the thermometer level is low when a principal step is initiated. The thermometer level is high when the task is almost completed.

The computer is also configured to present a horizontal thermometer 606. This thermometer can indicate the level of completion with respect to the overall process. That is, this thermometer can indicate how many of the principal steps have been completed by changing the color (or gray scale) of the thermometer to simulate the rising level of fluid in an actual thermometer. All level information presented in the horizontal and vertical thermometer charts can also be presented in numeric percentage format, or some alternative format.

An authorized individual can update the thermometer chart by entering relevant information through a keyboard or other input device (e.g., via mouse) in a manner well known to those skilled in the art. For instance, in one implementation, the computer is configured to present the chart using the Microsoft PowerPoint™ or Excel™ software programs, in which the screen may define a series of user entry fields. The user can enter symbols into the appropriate fields to designate progress through the process, such as by entering check marks in the thermometers via keyboard or mouse data entry. Alternatively, the computer can be configured to link information entered via another tool (such as a separate scheduling tool or sign-off worksheet) with progress data presented in the thermometer chart, such that the thermometer chart would automatically be updated upon data entry via the other scheduling tool.

Each of the fields in the thermometer chart may additionally include a link which provides access to additional information (e.g., by clicking on the field in the thermometer chart using a mouse, etc.). That is, the user can click on any principal step, substep, tollgate, deliverable, etc. to provide additional information regarding these topics (such as instructions, definitions, etc.). The chart may also be printed out and used as a hard-copy reference in performing the process.

The thermometer chart may also be designed to display different tasks in different colors to convey various information regarding the tasks. For instance, a team leader may configure the tool so that certain tasks are displayed in different colors to indicate their relative importance, difficulty, individuals being held accountable for completion of the tasks, etc.

Finally, FIG. 6 provides a series of tool icons 602. These tool icons may comprise the same tools identified in FIGS. 4 and 5. Alternatively, these icons may present an additional group of tools that are particularly adapted to interact with the thermometer presentation.

3. Tools for Use in Performing the Process

The interface may optionally include a number of tools that can be used in performing the steps of the process. Exemplary tools are identified in the right-hand column of FIGS. 1A-1N in association with the steps that they support. The following section provides additional detail regarding the tools. It should be noted, however, that the tools also have self-contained utility. That is, the tools identified below may be used in other applications, or as vehicles for stand-alone analysis.

3(a). Ansoff Model (Business Positioning Strategy Tool)

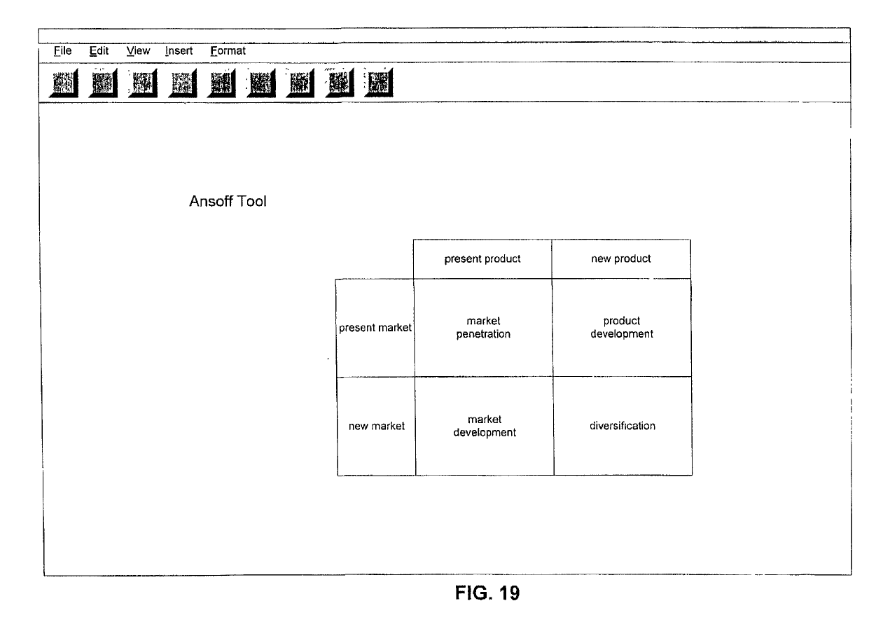

FIG. 19 illustrates the analysis approach used by the Ansoff tool. As shown there, the vertical axis identifies two categories of markets: present (existing) markets; and new markets. The horizontal axis identifies two categories of products: present (existing) products; and new products. The intersection of these categories defines four blocks. The upper left block defines solutions that reflect the marketing of existing products to existing customers (defining solutions aimed at market penetration). The lower left block defines solutions that reflect the marketing of new products to existing customers (defining solutions aimed at market development). The upper right block defines solutions that reflect the marketing of new products to existing customers (defining solutions aimed at product development). Finally, the lower right block defines solutions that reflect the marketing of new products to new customers (defining solutions aimed at diversifying the organization's markets). Hence, this tool provides an analytical technique for classifying (and thus better understanding) different business solutions.

3(b). Data Collection Plan

The data collection plan defines a document that sets forth a plan for collecting data. It may be structured in the form of a flow chart, or some other form. The document may be constructed from a template that identifies standard fields of information pertinent to the collection of data.

3(c). Brief-the-Supplier Information

The brief-the-supplier information constitutes a document that sets forth instructions that govern a supplier's collection of information on behalf of the team. The document may be constructed from a template that identifies standard fields of information pertinent to this subject matter.

3(d). Business Cause and Effect Diagram Tool

A business cause and effect diagram may use an inverted tree-structure to show how different attributes of an organization and its environment filter down and affect the organization's overall operation. That is, different branches represent different factors that influence the organization's overall operation. Each of these basic branches in the tree-structure may further include multiple contributing subfactors. For instance, FIG. 7 illustrates an exemplary cause and effect diagram. In this case, the team has identified the following principal factors as having an influence on the organization's overall operation: environmental influences; market-based influences; distribution-related influences; core-portfolio influences; business-expectation-related influences; business-infrastructure-related influences; etc. Each of these branches includes multiple contributing subfactors. For instance, the team has identified the following subfactors as contributing to the environmental influence: regulatory activity;

environmental activity; and financial market trends. The team may gain an appreciation of the impact of different attributes by tracing how these attributes affect the organization's more general operation.

3(e). CAP Assessment Tool

The Change Acceleration Process (CAP) model provides techniques which facilitate the introduction of change within the organization. More specifically, this tool allows proponents of change in the organization to identify potential obstacles to change (e.g., from a personnel/psychological standpoint). Further, this tool provides suggestions as to how the proponents might overcome these obstacles.

3(f). Collection Rules

Collection rules define a document that sets forth rules for collecting data in the MULTI-GENERATION process. For instance, these rules may define guidelines to assist the analyst in determining what data to collect, what data to ignore, where the data is to be obtained, how the data is be archived, etc. These rules may be structured in the form of a chart that lists various rules, an indexed rulebook, or some other form. The document may be constructed from a template that identifies standard fields of information pertinent to this subject matter.

3(g). Decision Tree Tool

The Decision Tree Tool (also known as the CTQ tree tool) comprises a decision tree that provides a framework for synthesizing critical information and measuring progress in the process. In this approach, the tool divides information that is deemed critical to the development of the process into various main categories, each comprising possible subcategories. Team members may use this tool as a checklist to ensure, in a structured manner, that important decisions have been addressed in the course of performing the process.

3(h). Discussion Guide

A discussion guide serves as a model for collecting various information pertaining to the organization and its relevant environment. The information includes: business expectation information; key challenges information; criteria for performing evaluation; situation analyses; infrastructure and capability analyses (to baseline the current status of the organization); product assessment information (for as is tool analysis); promotional strategy information; pricing/profitability information; customer life-time profitability information; customer retention data information (for life-cycle planning); distribution information, etc.

As the name suggests, the discussion guide may also serve a vehicle for discussing the data with a recipient of such information, such as the senior leaders.

3(i). Ease of Implementation Tools

The multi-generation process may use one or more tools for assessing the ease (i.e., relative difficulty) in implementing an identified business solution. The tools selected for this analysis may depend on the particular characteristics of the business and its relevant business environment. The following discussion identifies an exemplary sampling of tools for possible application.

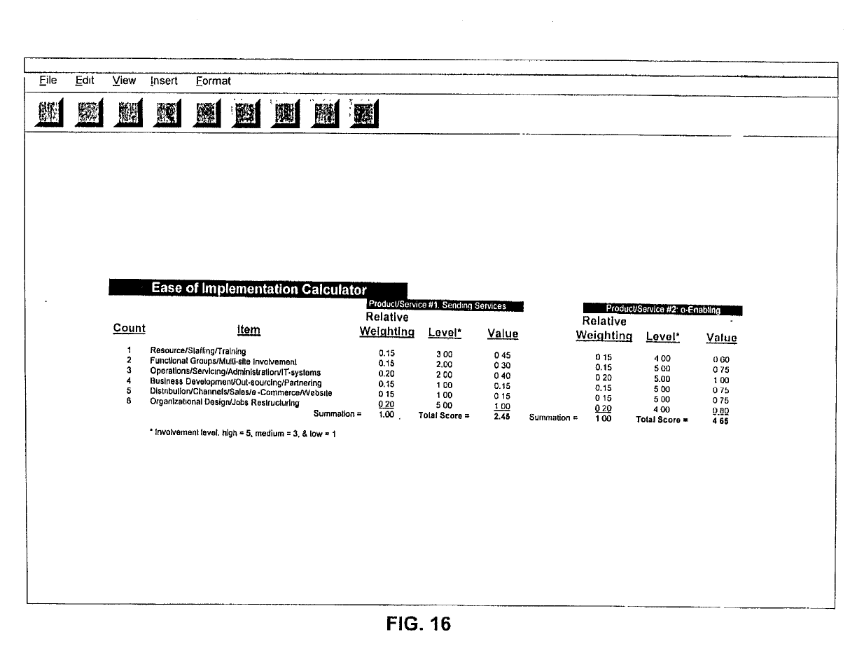

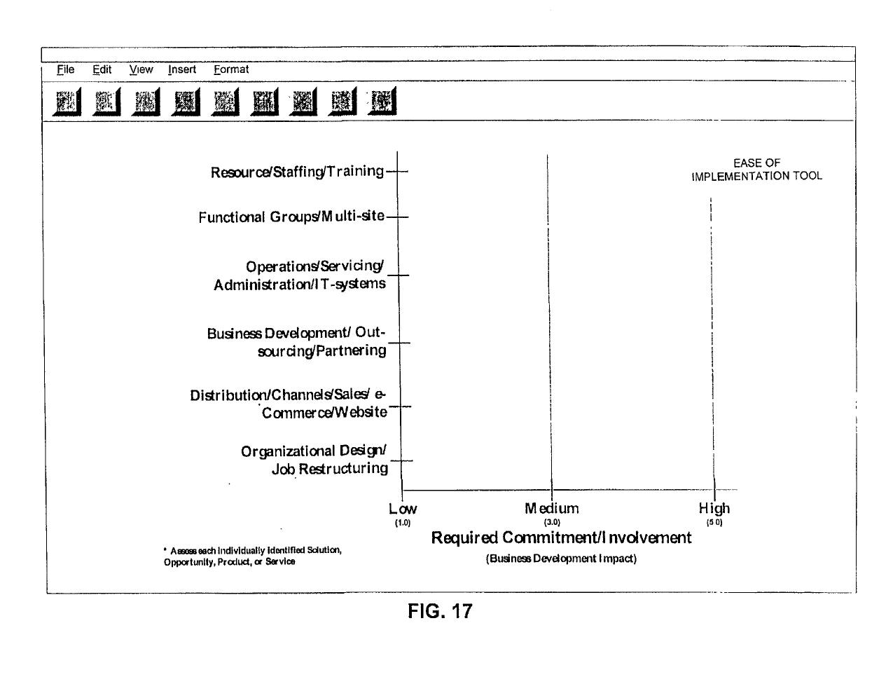

FIG. 16 shows one type of tool for application to the multi-generation process, referred to as an Ease of Implementation Calculator. This tool identifies various factors that have a bearing on the difficulty of implementing business solutions, including: resource/staffing/training requirements; functional groups/multi-site involvement requirements; operations/servicing/administration/technical systems requirements; business development/out-sourcing/partnering requirements; distribution/channels/sales/e-commerce/website requirements; and organization design/jobs restructuring requirements. Further, the tool identifies two product/services business solutions for consideration (labeled #1 and #2, respectively). The tool prompts the user to identify the level of involvement associated with each business solution for each of the above-identified factors (where a high level of involvement is assigned a value of 5, a medium level of involvement is assigned a level of 3, and a low level of involvement is assigned a level of 1). These levels are multiplied by respective weighting factors to provide a plurality of values. The tool then sums the values for each solution to provide an aggregate sum value. The aggregate sum values provide some comparative indication of whether solution #1 would be easier to implement than solution # 2, or vice versa. FIG. 17 provides a graphical technique for visualizing the same information discussed above in the context of FIG. 16.

Various other analysis techniques may be used to graphically assess the ease of implementing identified solutions. For instance, the team may use the GE model (discussed below) to explore the ease of implementing various solutions. In one exemplary application, the team may construct a GE model listing economic profile assessment along the model's vertical axis (having a range of low to high). This measure reflects how attractive the solutions are to the organization. The GE model lists ease of implementation along the model's horizontal axis. This measure reflects the business development impact of the solutions. The tool then prompts the user to position different solutions within this chart depending on their assessed economic profile (attractiveness) and ease of implementation (business development impact). Solutions that fall out into the upper left quadrant define highly desirable solutions. Solutions that fall out into the lower right quadrant define low priority solutions. Solutions that are located in other regions define solutions having intermediate or negotiable value. Another GE model may prompt the user to weigh market attractiveness (listed on the vertical axis) against ease of implementation (listed on the horizontal axis).

3(j). Exit Strategy

The exit strategy defines a document that sets forth the procedures and/or considerations for terminating or revising a strategy in the event that it encounters difficulty. This document may be constructed from a template that identifies standard fields of information pertinent to this subject matter.

3(k). FMEA Tool

FMEA analysis identifies failure modes (risks) facing business solutions, potential effects of the failures, severity of the failures, potential causes of the failures, relative occurrences of the failures, current controls and/or mitigants which may offset the effects of the failures, detectability of the failures, and recommended procedures to address the failures. This document may be constructed from a template (e.g., a chart) that identifies standard fields of information pertinent to this subject matter.

3(l). Financial/Economic Analysis, Various Planning Tools

The team may rely on various financial tools to assess, for instance, whether the organization has the ability to fund identified solutions (and whether the organization can continue to fund the identified solutions). The team may rely on other tools to assess the comparative economic merit of different tools.

3(m). GANTT Chart

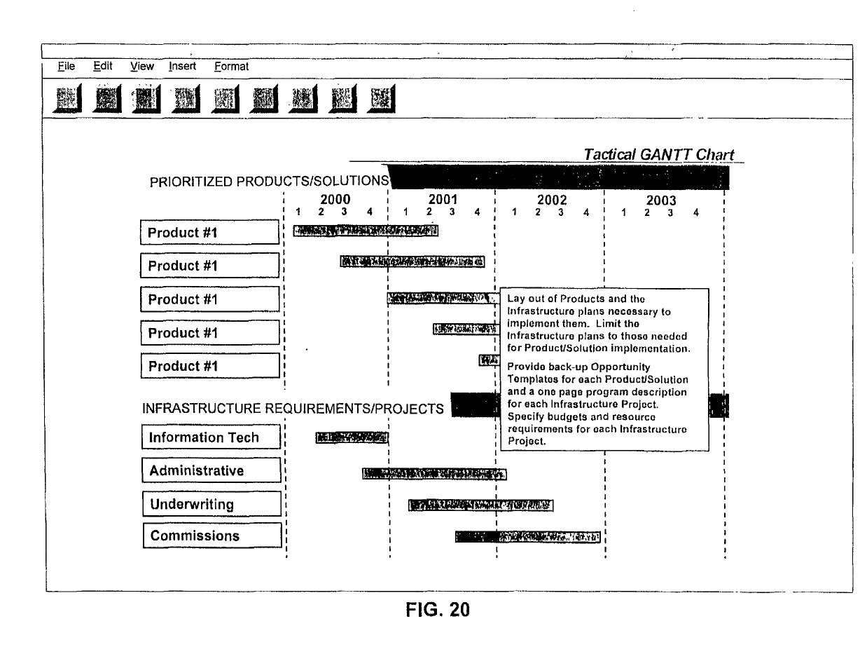

GANTT analysis identifies roll-out priority and timeframes for performing various activities. The GANTT analysis may also identify timeframes for which various resources will be required. As indicated by FIG. 20, typical GANTT analysis presents such timeframe information using an arrayed series of bars. The start of an exemplary bar indicates the commencement of an associated timeframe, and the end of such bar indicates the completion of the associated timeframe. The length of such bar graphically indicates the length of the timeframe.

3(n). Gap Assessment Tool

The gap assessment tool defines a document that serves as a guide for assessing data and analytical deficiencies at various stages in the process, for memorializing these deficiencies, and for potentially addressing these deficiencies. This document may be constructed from a template that identifies standard fields of information pertinent to this subject matter.

3(o). GE Model (9-Blocker Model) Tool

FIG. 15 illustrates the basic approach used by the GE model. As indicated there, the vertical y axis quantities industry attractiveness into low, medium, and high values. Industry attractiveness may depend on multiple factors, such as market growth, pricing, market diversity, competitive structure, technical role, social impact, profitability, environmental impact, etc. The horizontal axis x quantifies business strength into strong, average, and weak. Business strength may also depend on multiple factors, such as market position, margin, technology position, size, growth potential, environmental record, etc. The two axes, each divided into three gradations, define nine different permutations of criteria within the grid itself. As such, the GE model is also referred to as a 9-Blocker tool, as indicated above.

In operation, the team assesses the respective attractiveness and strengths of the products and services in the organization's portfolio, and then places the products and services at appropriate locations on the grid as a function of such assessment. The positions of the products and services on the grid thus clearly convey the relative merits of different business solutions. That is, products and services placed in the upper left quadrant of the model generally define solutions having high priority. Products and services placed in the lower right quadrant generally define solutions having low priority. Products and services positioned in other regions of the model have negotiable or intermediate value.

3(p). Hypothesis Template

The hypotheses template defines a document that serves as a guide for collecting and documenting hypotheses generated in the course of performing the multi-generation process. This document may be constructed from a template that identifies standard fields of information pertinent to this subject matter.

3(q) Infrastructure Growth Plan

The infrastructure growth plan defines a document that identifies the organization's planned infrastructure growth. This document may be constructed from a template that identifies standard fields of information pertinent to this subject matter.

3(r) Opportunities Collection Plan & Template

The opportunities collection plan defines a document that identifies a procedure for noting and documenting opportunities that may arise in performance of the multi-generation process. This document may be constructed from a template that identifies standard fields of information pertinent to this subject matter.

3(s). Positional Radar Chart

The radar chart presents an axis that identifies a property of the business. The chart also identifies a range of values along the axis that represent the extent to which different businesses embody the identified property. The tool prompts the user to identify their organization's current position on the axis, as well as their target position (i.e., where they want to be, or should be). This tool therefore provides an easily understood means for visualizing the gap that separates the organization from its objectives.

3(t). Prioritization Tool (including Strategy, Market and Product Prioritization Tools)

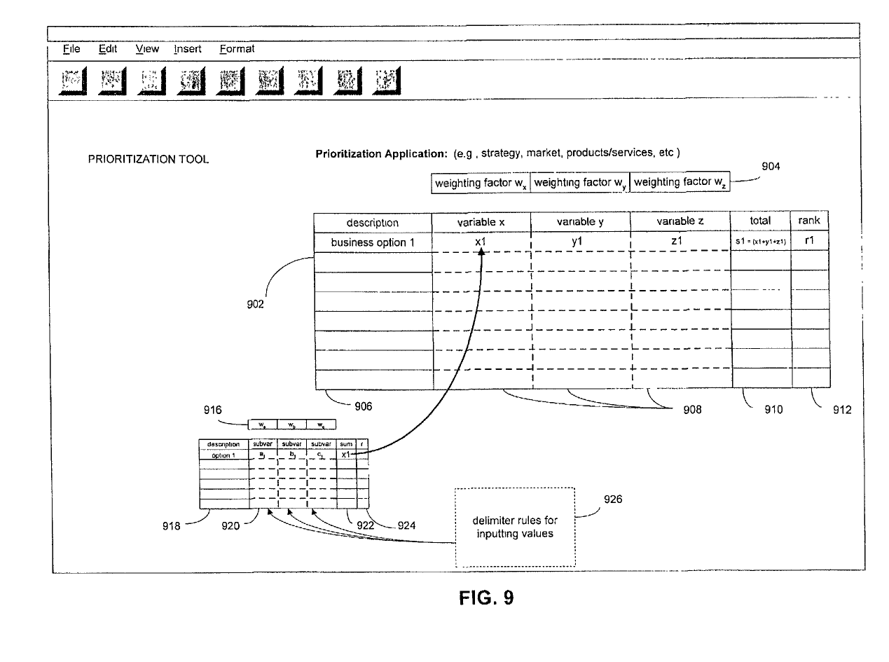

FIG. 9 illustrates a high-level depiction of the prioritization tool. As indicated there, the tool may be applied to a plurality of different fields of analysis (including strategy prioritization, market prioritization, products/services prioritization, etc.). A primary matrix 902 includes a field 906 for identifying a plurality of options relating to the selected field of analysis. For instance, field 906 would identify a plurality of strategies in the event that the tool was applied to the task of strategy prioritization. The field 906 would identify a plurality of markets in the event that the tool was applied to the task of market prioritization.

The primary matrix 902 also includes a field 908 for storing values pertaining to a plurality of variables (e.g., in this exemplary model, variables x, y and z). These variables define high-level attributes of the basic field of analysis. For instance, the tool may identify the following variables as useful in prioritizing strategies: (a) market impact; (b) business impact/implications; (c) business risk; and (d) financial impact/implications. The tool may identify the following variables as useful for prioritizing markets: (a) market potential; (b) expansion potential; (c) business risk; and (c) profit potential. The identified variables are suitable for many business applications (and thus may be considered generic). However, those skilled in the art will appreciate that an analyst may select a different set of variables to perform the prioritization to suit the unique characteristics of a particular business environment and/or a particular market.

The values stored in field 908 reflect the user's assessment of the degree to which the options listed in the field 906 satisfy the high-level variables. In a preferred embodiment, the tool may provide guidance to the user in making such assessments. For instance, whenever possible, the tool associates specific numerical values with identified factual patterns. As such, if a user determines that an identified factual pattern applies to a question under consideration, the tool guides the user to enter a specific value assigned to that fact pattern. This reduces the risk that the user may use the prioritization tool to simply validate preconceived notions regarding the desirability of different business options.

Field 910 stores the summation of values in field 908 for respective business options. In the specific embodiment illustrated in FIG. 9, the values entered in field 908 are also multiplied by respective weighting factors (identifies in field 904) to form weighted values, and these weighted values are then summed together and placed in field 910. That is, for the first business option listed in the matrix 902, the sum S1 is given by S1=wx*xl+wy*yl+wz*zl, where wz, wy, and wz represent different weighting factors entered in field 904, and xl, yl, and zl reflect different values entered in field 908 for the first-listed business option in field 910. Finally, field 912 of matrix 902 ranks the business options identified in field 906 according to their respective sums listed in field 910. A top-ranked business option is associated with a potentially desirable business solution.

In other embodiments, the values entered into field 908 may reflect the results of separate prioritization analysis. For instance, the value xl may reflect the weighted sum derived form a separate prioritization matrix 914. This prioritization matrix 914 may include a similar structure to the primary prioritization matrix 902. Namely, the prioritization matrix 914 may include a description field 918 (listing the same business options as field 906 of matrix 902), a values-entry field 920, a weighting field 916, a summation field 922, and ranking field 924. A plurality of sub-variables govern the entry of values of into field 920. In the instant case, these sub-variables bear a species-type relationship to the genre identified by variable x of matrix 902.

Further, as mentioned above, the tool may provide specific rules (e.g., represented by delimiter rules 926) that govern the entry of values into field 920 of matrix 914. That is, these delimiter rules 926 prompt the user to enter specific numerical values if specific facts apply to the questions under consideration. As noted above, these delimiters better ensure that the application of the tool reflects an objective assessment of reality, rather than an overly subjective and haphazard application of weighting factors to force a recommendation to suit a preconceived bias.

FIGS. 10-14 illustrate an exemplary application of the prioritization matrix approach to the prioritization of markets. Namely, FIG. 10 shows the main matrix, corresponding to matrix 902 in FIG. 9. That matrix identifies a plurality of target market segments, and a plurality of variables pertaining to the target market segments. Values entered into this matrix reflect the user's assessment of the extent to which the identified market segments embody the properties identified by the variables. FIGS. 11-14 show individual matrices that may be used to compute the values entered into the main matrix of FIG. 10. The specific data entry rules (located near the bottom of FIGS. 11-14) provide an example of how this tool constrains the user in inputting values to the matrices.

The strategy prioritization tool and the product prioritization tool are based on a similar model to that described in the context of FIGS. 10-14.

3(u). Process Overview Presentation

The process overview presentation defines a document that provides an overview of the multi-generation process, e.g., for presentation to senior leaders in a kick-off session. This document may be constructed from a template that identifies standard fields of information pertinent to this subject matter.

3(v). Project Checklist

The process checklist, as the name suggests, provides a checklist for use during the execution of the process to ensure that identified tasks have been completed, identified decisions have been made, identified tools have been used, and identified deliverables (including documents) have been generated. This document may be constructed from a template that identifies standard fields of information pertinent to this subject matter.

3(w). QFD Tool

The Quality Function Deployment (QFD) analysis identifies how various features of the organization correlate with each other. More specifically, an exemplary QFD tool may comprise a series of interrelated matrices. A first matrix may include axes respectively identifying properties A and B, and may present information within the matrix relevant to different values (or aspects) of these two properties. A second matrix may include axes respectively identifying properties B and C, and may present information within the matrix relevant to different values (or aspects) of these two properties. A third matrix may include axes respectively identifying properties C and D, and may present information within the matrix relevant to different values (or aspects) of these two properties. Additional matrices may include yet further interrelated properties. Hence, in use, a user may select any piece of information in any matrix, and then drill down or drill up in the series of interrelated matrices to identify how this information relates to and potentially impacts other fields of information.

In an exemplary context contemplated by the present invention, the matrices may prevent information which interrelates market-related information with product-related information. For instance, the tool may link properties such as market segment information, voice of customer information (VOC), needs-related information (CTQs), financial solution information, distribution method information, etc. This tool thus provides a powerful multi-dimensional information space in which to navigate through the linked information, and in the process, gain new insights regarding the organization's business environment.

3(x). Risk Verses Novelty Tool

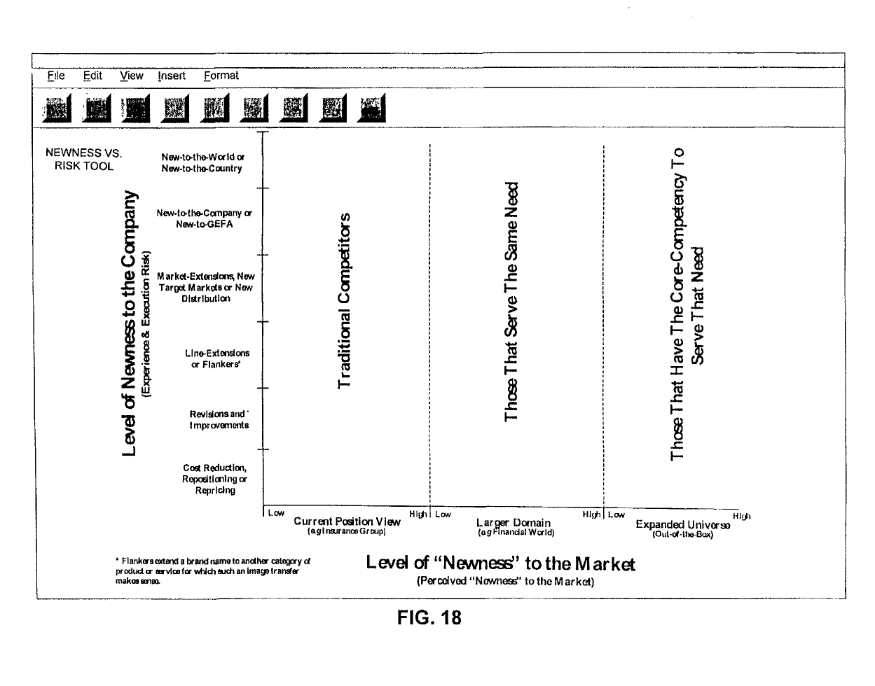

FIG. 18 illustrates an exemplary risk verses newness tool. The vertical axis of this model identifies level of newness to the company. This axis specifically identifies gradations of newness corresponding to: cost reduction, reposition or repricing (representing the lowest level of newness); revisions and improvements; line-extensions or flankers; market-extensions, new target markets or new distributions; new to the company or new to a particular division within the company; and new to the world or new to the country (representing the highest level of newness). The newness to the company generally correlates with risk to the company (i.e., the newer the solution, the greater the risk).

The horizontal axis of the model identifies level of newness to the market. This axis specifically identifies different categories of markets, including: current position view (e.g., within a particular insurance group); larger domain (e.g., within a particular financial community); and expanded universe (e.g., representing an inclusive out of the box category). Within each category, the axis identifies gradations of newness from low to high.

The tool prompts the user to place solutions onto the grid at locations that match their assessed newness, as defined above. This tool provides insight regarding the relative merits of different solutions. The segmentation of the market into different domains ensures that the user is comparing solutions with respect to appropriate groups of potential competitors.

3(y). Service and Distribution Assessment Tool

The Service and Distribution Assessment Tool may use the GE Model tool framework (described above) for providing a what if service and distribution assessment. This tool is particularly useful in those cases where distribution is a key component in the distribution of a product.

3(z). Strategic Work-Out Template Tool

The Strategic Work-Out Template tool defines a document that provides a guideline which may assist a user in performing the strategic work-out portion of the multi-generation process. This document may, for instance, comprise a flowchart that identifies tasks, and/or may itself include a collection of separate tools. This document may be constructed from a template that identifies standard fields of information pertinent to this subject matter.

3(z-a). SWOT Analysis Tool

SWOT is an acronym for Strengths, Weaknesses, Opportunities, and Threats). FIG. 8 shows an example of the SWOT tool as applied to one exemplary business setting. As shown there, this tool includes a four-block grid for identifying strategies that may be used by the organization to market its products and services. The right side of the grid lists various strengths and weaknesses of the organization. These factors reflect characteristics of the organization which may be attributed to its internal makeup/constitution. The top side of the grid lists various opportunities presented to the organization and various threats facing the organization. These factors reflect characteristics of the organization's environment. For instance, an exemplary opportunity may identify a market segment that is current under-exploited by competitors, thus representing an opportunity for exploitation by the organization. An exemplary threat may identify any type of potential impediment to the organization's profitability, such as regulative threats, or market-based threats, etc.

Within the grid itself, the upper-left box identifies those strategies that are appropriate in view of the identified strengths of the organization, coupled with its identified opportunities. The lower-left box identifies those strategies that are appropriate in view of the identified weaknesses of the organization, coupled with its identified opportunities. The upper-right box identifies those strategies that are appropriate in view of the organization's identified strengths, coupled with its identified threats. And the lower-right box identifies those strategies that are appropriate in view of the organization's identified weaknesses coupled with its identified threats. The tool may label the strategies placed in the boxes using appropriate codes to reflect the considerations on which they are based (e.g., using symbols S, W, O, and T to represent the type of factors that the strategy addresses, i.e., corresponding to Strengths, Weaknesses, Opportunities, Threats, etc.).

3(z-b). Tactical Work-Out Template Tool

The Tactical Work-Out Template tool defines a document that provides a guideline which may assist a user in performing the tactical work-out portion of the multi-generation process. This document may, for instance, comprise a flowchart that identifies tasks, and/or may itself include a collection of separate tools. This document may be constructed from a template that identifies standard fields of information pertinent to this subject matter.

Still other procedures and tools for potential use in the above-described method and system are identified in commonly assigned U.S. application Ser. No. 09/293,398, filed on Apr. 16, 1999, entitled System and Method for Developing and Managing a Financial Service Product, which is incorporated by reference herein in its entirety. Still other procedures and tools for use in the above-described method and system are identified in commonly assigned U.S. application Ser. No. 09/475,693, filed on Dec. 31, 1999, entitled System and Method for Developing and Managing a Financial Service Product, which is also incorporated by referenced herein in its entirety.

To facilitate explanation, the above discussion was framed in the context of an exemplary business environment characterized by defined exemplary business considerations. However, it should be noted that the principles described here apply to many different business and non-business environments having correspondingly different considerations.

More generally, various modifications to the embodiments described above can be made without departing from the spirit and scope of the invention, as is intended to be encompassed by the following claims and their legal equivalents.

1. A method for performing business planning using a structured process, so as to provide a marketing solution to an organization, comprising the steps of:
in a first stage, chartering the process by defining its objective based on input from at least one senior leader of the organization, and developing a plan for collecting data to reach that objective;
in a second stage, gathering data pertaining to the organization's environment from secondary and primary sources, and performing preliminary structuring and assessment of such data;
in a third stage, conducting a strategic workout session with the at least one senior leader, including developing, bundling and prioritizing candidate solutions; and
in a fourth stage, conducting a tactical workout session, including allocating resources to implement a selected solution.

2. The method of claim 1, wherein the first stage further includes performing a SWOT analysis procedure, the SWOT analysis procedure comprising the steps of:
identifying strengths and weaknesses relevant to the organization;
identifying opportunities presented to the organization, and threats facing the organization; and
identifying candidate solutions based on a consideration of the identified strengths, weaknesses, opportunities, and threats.

3. The method of claim 1, wherein the first stage further includes performing a strategy prioritization procedure, comprising the steps of:
identifying a plurality of strategies for achieving the marketing solution, wherein the procedure defines a plurality of variables that describe respective properties of the strategies;
specifying values for the variables which reflect the extent to which the strategies embody the properties;
summing the values for each of the strategies to produce a plurality of sum values; and
ranking the strategies based on the plurality of sum values.

4. The method of claim 3, wherein the step of specifying values comprises specifying values selected from a predefined group of delimiter values associated with respective factual patterns.

5. The method of claim 1, wherein the second stage further includes performing a market prioritization procedure, comprising:
identifying a plurality of markets for achieving the marketing solution, wherein the procedure defines a plurality of variables that describe respective properties of the markets;
specifying values for the variables which reflect the extent to which the markets embody the properties;
summing the values for each of the markets to produce a plurality of sum values; and
ranking the markets based on the plurality of sum values.

6. The method of claim 5, wherein the step of specifying values comprises specifying values selected from a predefined group of delimiter values associated with respective factual patterns.

7. The method of claim 1, wherein the second stage further includes performing a multi-blocker model procedure, comprising:
identifying the attractiveness of a plurality of candidate solutions;
identifying the business strengths of the plurality of candidate solutions; and
placing indicia representing the candidate solutions on a grid as a function of the identified attractiveness and strengths of the respective plurality of candidate solutions.

8. The method of claim 1, wherein the third stage further includes performing a risk verses newness procedure, comprising:
identifying the level of newness to the organization with respect to a plurality of candidate solutions;
identifying the level of newness to the market with respect to the plurality of candidate solutions, with respect to a plurality of marketing domains; and
placing indicia representing the candidate solutions on a grid as a function of the solutions” identified newness to the organization and newness to the market.

9. A method for performing business planning using a structured process, so as to provide a marketing solution to an organization, comprising the steps of:
in a first principal step, chartering the process and defining its objectives on the basis of information obtained from at least one senior leader of the organization;
in a second principal step, gathering baseline information that defines the current position of the organization;
in a third principal step, developing strategy hypotheses and a data collection plan for achieving the objectives identified in the first principal step;
in a fourth principal step, collecting and analyzing previously prepared data from secondary data sources;
in a fifth principal step, collecting data from primary sources using resources that are internal to the organization;
in a sixth principal step, collecting data from primary sources that are external to the organization;
in a seventh principal step, combining and analyzing information extracted in at least the fourth through sixth principal steps;
in an eighth principal step, identifying and assessing opportunities for providing the marketing solution;
in an ninth principal step, reviewing and generating opportunities by conducting a strategic planning session with at least one senior leader of the organization;
in a tenth principal step, assessing and prioritizing the opportunities identified in the prior principal steps;
in an eleventh principal step, developing a high-level plan for carrying out the marketing solution;
in a twelfth principal step, developing a measurement system and assessing risk in connection with implementing the marketing solution;
in a thirteenth principal step, determining criteria for assessing the success of the solution and projecting the impact of changes in the organization that will be caused by the solution; and
in a fourteenth principal step, developing detailed action plans to implement the solution.

10. A method for performing business planning so as to provide a marketing solution to an organization, comprising the steps of:
storing a kit, the kit including:
a representation of a structured process for developing the market solution, the structured process prompting a user to apply tools at specified junctures in the process;
a plurality of tools for use in performing the process;
accessing the kit; and
using the kit by performing the process specified in the kit using at least one of the tools contained in the kit,
wherein the process prompts a user to perform the steps of:
in a first stage, chartering the process by defining its objective based on input from at least one senior leader of the organization, and developing a plan for collecting data to reach that objective;
in a second stage, gathering data pertaining to the organization's environment from secondary and primary sources, and performing preliminary structuring and assessment of such data;
in a third stage, conducting a strategic workout session with the at least one senior leader, including developing, bundling and prioritizing candidate solutions; and
in a fourth stage, conducting a tactical workout session, including allocating resources to implement a selected solution.

11. The method according to claim 10, wherein the step of storing comprises storing the kit in an electronic storage medium.

12. The method according to claim 11, wherein the step of accessing comprises accessing the kit using a computer workstation.

13. The method according to claim 12, where the step of using comprises interacting with the representation of the process and the plurality of tools using the computer workstation.

14. A kit for performing business planning so as to provide a marketing solution to an organization, comprising:
a representation of a structured process for developing the marketing solution, the structured process prompting a user to perform tools at specified junctures in the process; and
a plurality of tools for use in performing the process, wherein the process prompts the user to perform the steps of:
in a first stage, chartering the process by defining its objective based on input from at least one senior leader of the organization, and developing a plan for collecting data to reach that objective;
in a second stage, gathering data pertaining to the organization's environment from secondary and primary sources, and performing preliminary structuring and assessment of such data;
in a third stage, conducting a strategic workout session with the at least one senior leader, including developing, bundling and prioritizing candidate solutions; and
in a fourth stage, conducting a tactical workout session, including allocating resources to implement a selected solution.

15. The kit of claim 14, where the plurality of tools includes a SWOT analysis tool, the SWOT analysis tool being configured to prompt the user to:
identify strengths and weaknesses relevant to the organization;
identify opportunities presented to the organization, and threats facing the organization; and
identify candidate solutions based on a consideration of the identified strengths, weaknesses, opportunities, and threats.

16. The kit of claim 14, wherein the plurality of tools includes a strategy prioritization tool, the strategy prioritization tool being configured to prompt the user to:
identify a plurality of strategies for achieving the marketing solution, wherein the procedure defines a plurality of variables that describe respective properties of the strategies;
specify values for the variables which reflect the extent to which the strategies embody the properties;
sum the values for each of the strategies to produce a plurality of sum values; and
rank the strategies based on the plurality of sum values.

17. The kit of claim 16, wherein the tool is configured to restrict the specified values to a predefined group of delimiter values associated with respective factual patterns.

18. The kit of claim 14, wherein the plurality of tools includes a market prioritization tool, the market prioritization tool being configured to prompt the user to:
identify a plurality of markets for achieving the marketing solution, wherein the procedure defines a plurality of variables that describe respective properties of the markets;
specify values for the variables which reflect the extent to which the markets embody the properties;
sum the values for each of the markets to produce a plurality of sum values; and
rank the markets based on the plurality of sum values.

19. The kit of claim 18, wherein the tool is configured to restrict the specified values to a predefined group of delimiter values associated with respective factual patterns.

20. The kit of claim 14, wherein the plurality of tools includes a multi-blocker tool, the multi-blocker tool being configured to prompt the user to:
identify the attractiveness of a plurality of candidate solutions;
identify the business strengths of the plurality of candidate solutions; and
place indicia representing the candidate solutions on a grid as a function of the identified attractiveness and strengths of the respective plurality of candidate solutions.

21. The kit of claim 14, wherein the plurality of tools includes a risk verses newness tool, the risk verses newness tool being configured to prompt the user to:
identify the level of newness to the organization with respect to a plurality of candidate solutions;
identify the level of newness to the market with respect to the plurality of candidate solutions, with respect to a plurality of marketing domains; and
place indicia representing the candidate solutions on a grid as a function of the solutions” identified newness to the organization and newness to the market.

22. The kit of claim 17, wherein the kit is formed by digital data.

23. A kit for performing business planning so as to provide a marketing solution to an organization, comprising:
a representation of a structured process for developing the marketing solution, the structured process prompting the user to use tools at specified junctures in the process; and
a plurality of tools for use in performing the process,
wherein the process prompts a user to perform the steps of:
in a first principal step, chartering the process and defining its objectives on the basis of information obtained from at least one senior leader of the organization;
in a second principal step, gathering baseline information that defines the current status of the organization;
in a third principal step, developing strategy hypotheses and a data collection plan for achieving the objectives identified in the first principal step;
in a fourth principal step, collecting and analyzing previously prepared data from secondary data sources;
in a fifth principal step, collecting data from primary sources using resources that are internal to the organization;
in a sixth principal step, collecting data from primary sources that are external to the organization;
in a seventh principal step, combining and analyzing information extracted in at least the fourth through sixth principal steps;
in an eighth principal step, identifying and assessing opportunities for providing the marketing solution;
in an ninth principal step, reviewing and generating opportunities by conducting a strategic planning session with at least one senior leader of the organization;
in a tenth principal step, assessing and prioritizing the opportunities identified in the prior principal steps;
in an eleventh principal step, developing a high-level plan for carrying out the marketing solution;
in a twelfth principal step, developing a measurement system and assessing risk in connection with implementing the marketing solution;
in a thirteenth principal step, determining criteria for assessing the success of the plan and projecting the impact of changes in the organization on the solution; and
in a fourteenth principal step, developing detailed action plans to implement the solution.

24. A system for performing a business planning method so as to provide a marketing solution to an organization, comprising:
a database for storing a kit, the kit including:
a structured process for developing the marketing solution, the structured process prompting a user to apply tools at specified junctures in the process;
a plurality of tools for use in performing the process;
an access device for receiving the kit and for performing the process using the access device,
wherein the process prompts a user to perform the steps of:
in a first stage, chartering the process by defining its objective based on input from at least one senior leader of the organization, and developing a plan for collecting data to reach that objective;
in a second stage, gathering data pertaining to the organization's environment from secondary and primary sources, and performing preliminary structuring and assessment of such data;
in a third stage, conducting a strategic workout session with the at least one senior leader, including developing, bundling and prioritizing solutions; and
in a fourth stage, conducting a tactical workout session, including allocating resources to implement a selected solution.

25. The system of claim 24, wherein the access device comprises a computer workstation.
